(19) United States
(12) Patent Application Publication
(10) Pub. No.: US 2017/0091810 A1
(43) Pub. Date: Mar. 30, 2017

(54) BRAND ENGAGEMENT TOUCHPOINT ATTRIBUTION USING BRAND ENGAGEMENT EVENT WEIGHTING

(71) Applicants: Michael McGovern, Arlington, MA (US); Philip Gross, Newton, MA (US); Payman Sadegh, Alpharetta, GA (US); Anto Chittilappilly, Waltham, MA (US)

(72) Inventors: Michael McGovern, Arlington, MA (US); Philip Gross, Newton, MA (US); Payman Sadegh, Alpharetta, GA (US); Anto Chittilappilly, Waltham, MA (US)

(21) Appl. No.: 15/137,628

(22) Filed: Apr. 25, 2016

Related U.S. Application Data
(60) Provisional application No. 62/234,569, filed on Sep. 29, 2015.

(51) Int. Cl. G06Q 30/02; G06N 99/00

(52) U.S. Cl. CPC G06Q 30/0246; G06Q 30/0247; G06N 99/005

(57) ABSTRACT

A method, system, and computer program product for classifying, weighting, and quantifying audience responses to stimulation. A method commences by forming a predictive model comprising parameters derived from response data records taken from the Internet and stimulus data records takers item the performance or execution of a media plan. A database of user configurations is consulted to access brand engagement event weighting parameters. The brand engagement event weighting parameters are combined with simulation data to generate weighted touchpoint contribution values that can in turn be used to predict future responses front the audience or a similar future audience. The weighted touchpoint contribution values are used to calculate audience engagement scores. A selected set of audience engagement scores are used to determine spending in a media plan.

### RELATED APPLICATIONS

The present application claims the benefit of priority to co-pending U.S. Provisional Patent Application Ser. No. 62/234,569, entitled “Brand Engagement Touchpoint Attribution Using Brand Engagement Event Weighting” (Attorney Docket No. VISQ.P0033P), filed Sep. 29, 2015, which is hereby expressly incorporated by deference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of classifying and quantifying audience responses to Internet stimulation and more particularly to techniques tor brand engagement touchpoint attribution using brand engagement event weighting.

### BACKGROUND

The prevalence of Internet or online advertising and marketing continues to grow at a fast pace. Today, a prospect (e.g., user) in a given target audience can experience a high number of exposures to a brand and/or product messaging (e.g., touchpoints) across multiple digital or “online” media channels (e.g., display, paid search, paid social, mobile site, email, etc.) and/or multiple non-digital or “offline” media channels (e.g., TV, radio, direct mail, etc.) on the journey to conversion (e.g., buying a product, completing an application, etc.) and/or to some other engagement state (e.g., brand introduction, brand awareness, etc.). Further, another user in the same target audience might experience a different combination or permutation of touchpoiots and channels, yet might not convert nor reach a given engagement state.

Large volumes of data characterizing the user interactivity with such high numbers of touchpoints is continuously collected in various forms (e.g., touchpoint attribute records, cookies, log files, pixel tags, mobile tracking, offline files, etc.) by the online advertising ecosystem using today's always on, always connected Internet technology. In some cases, such touchpoint data might be used by direct response marketing managers to predict the impact the touchpoints might have on a specific conversion event (e.g., online purchase).

In comparison, brand marketing managers might create multiple experiences (e.g., brand engagement events) that provide various opportunities for prospects to engage with a brand. Such brand engagement events might collectively serve as a key performance indicator (KPI) for brand marketing managers. The brand marketing manager of today desires to also leverage the continuous and voluminous stream of touchpoint data to learn how certain marketing tactics are impacting user brand engagement (e.g., engagement KPI), so as to be aware of audience engagement with the brand, and so as to make better informed marketing decisions, such as those related to media spend allocation.

Certain “bottom-up” touchpoint response predictive modeling techniques can collect user level stimulus and response data (e.g., touchpoint attribute data, conversion data, etc.) to assign conversion credit to every touchpoint and touchpoint attribute (e.g., ad size, placement, publisher, creative, offer, etc.) experienced by every converting user -and non-converting user across all channels. For example, such techniques can predict the contribution of a given touchpoint to reach a certain conversion event (e.g., online product purchase) for a given segment of users and/or media channels. In some cases, the “conversion” event might be defined as a brand engagement event (e.g., first-time website visit, whitepaper download, etc.). The foregoing predictive models can then predict the contribution of a given touchpoint to reaching the brand engagement event. Unfortunately, such touchpoint response predictive modeling techniques provide insight associated with a given brand engagement event, but are limited at least in their ability to reveal to the brand marketing manager the impact the touchpoint has on an overall brand engagement metric for a subject audience.

Techniques are needed to address the problem of estimating the effect various touchpoints have on the overall brand engagement of a subject audience. Furthermore, none of the aforementioned legacy approaches achieve the capabilities of the herein-disclosed techniques for brand engagement touchpoint attribution using brand engagement event weighting. Therefore, there is a need for improvements.

### BRIEF DESCRIPTION OF THE DRAWINGS

FIG. 1A depicts techniques for brand engagement touchpoint attribution using brand engagement event weighting, according to some embodiments.

FIG. 1B is an environment in which embodiments of the present disclosure can operate.

FIG. 2A presents a touchpoint response predictive modeling technique used in systems for brand engagement touchpoint attribution using brand engagement event weighting.

FIG. 2B presents a touchpoint attribute chart showing sample attributes associated with touchpoints of a media campaign, according to some embodiments.

FIG. 2C illustrates a touchpoint attribution technique used in systems for brand engagement touchpoint attribution using brand engagement event weighting, according to some embodiments.

FIG. 3A depicts brand engagement event weighting assignments used in systems for brand engagement touchpoint attribution using brand engagement event weighting, according to some embodiments.

FIG. 3B presents a touchpoint contribution value weighting technique used in systems for brand engagement touchpoint attribution using brand engagement event weighting, according to some embodiments.

FIG. 3C illustrates a true engagement score generation technique used in systems for brand engagement touchpoint attribution using brand engagement event weighting, according to some embodiments.

FIG. 4A depicts a subsystem for determining brand engagement touchpoint attribution using brand engagement event weighting, according to some embodiments.

FIG. 4B is a flowchart for determining brand engagement touchpoint attribution using brand engagement event weighting, according to some embodiments.

FIG. 5 is a use model How used in systems for brand engagement touchpoint attribution using brand engagement event weighting, according to some embodiments.

FIG. 6A presents a brand engagement event configuration interface for use in systems for brand engagement touchpoint attribution using brand engagement event weighting, according to some embodiments.

FIG. 6B presents a media channel engagement performance interface for use in systems for brand engagement touchpoint attribution using brand engagement event weighting, according to some embodiments.

FIG. 7 presents a digital channel conversion impact interface for use in systems for brand engagement touchpoint attribution using brand engagement event weighting, according to some embodiments.

FIG. 8 presents a broadcast network spot performance interface for use in systems for brand engagement touchpoint. attribution using brand engagement event weighting, according to some embodiments.

FIG. 9A and FIG. 9B present block diagrams of systems for brand engagement touchpoint attribution using brand engagement event weighting, according to an embodiment.

FIG. 10A and FIG. 10B depict block diagrams of computer system components suitable for implementing embodiments of the present disclosure.

### DETAILED DESCRIPTION

### Overview

Certain “bottom-up” touchpoint response predictive modeling techniques can collect user level stimulus and response data (e.g., touchpoint attribute data, conversion data, etc.) to assign conversion credit to every touchpoint and touchpoint attribute (e.g., ad size, placement, publisher, creative, offer, etc.) experienced by every converting user and non-converting user across all channels. For example, such techniques can predict the contribution of a given touchpoint towards reaching a certain conversion event (e.g., an online product purchase) for a given segment of users and/or media channel. In some cases, the “conversion” event might be defined as a brand engagement event (e.g., first-time website visit, whitepaper download, etc.). Disclosed herein are touchpoint response predictive modeling techniques that provide insight associated with a given brand engagement event, which insight serves to reveal to the brand marketing manager the impact that the touchpoint has on an overall brand engagement metric (e.g., key performance indicator) for a subject audience.

A true engagement score engine for dynamically receiving brand engagement event weighting parameters and generating true engagement scores for touchpoints associated with a given brand engagement campaign is disclosed herein. The true engagement score engine applies the brand engagement event weighting parameters to a set of touchpoint contribution values predicted by a touchpoint response predictive model to determine a respective set of weighted touchpoint contribution values. The weighted touchpoint contribution values are combined across user segments and/or engagement events and/or other dimensions to generate the true engagement scores. Certain performance parameters derived from the true engagement scores can be presented to the brand marketing manager by a media planning application.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used hi this application and die appended claims should generally be construed to mean “one or more” unless specified otherwise or is clear from the context to be directed to a singular form.

### Solutions Rooted in Technology

The appended figures and corresponding discussion given herein provides sufficient disclosure to make and use systems, methods, and computer program products that address the aforementioned issues with legacy approaches. More specifically, the present disclosure provides a detailed description of techniques used in systems, methods, and in computer program products for brand engagement touchpoint attribution using brand engagement event weighting. Certain embodiments are directed to technological solutions for receiving brand engagement event weighting parameters characterizing the relative impact of certain brand engagement events on an overall brand engagement to generate touchpoint true engagement scores representing the respective contribution of the touchpoints for obtaining die overall brand engagement, which embodiments advance the relevant technical fields as well as advancing peripheral technical fields.

The disclosed embodiments modify and improve over legacy approaches. In particular, the herein-disclosed techniques provide technical solutions that address the technical problems attendant to estimating effects that various touchpoint have on the overall brand engagement of a subject audience. Such technical solutions serve to reduce use of computer memory, reduce demand for computer processing power, and reduce communication overhead needed. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to computer modeling.

Reference is now made in detail to certain embodiments. The disclosed embodiments are not intended to he limiting of the claims.

### DESCRIPTIONS OF EXEMPLARY EMBODIMENTS

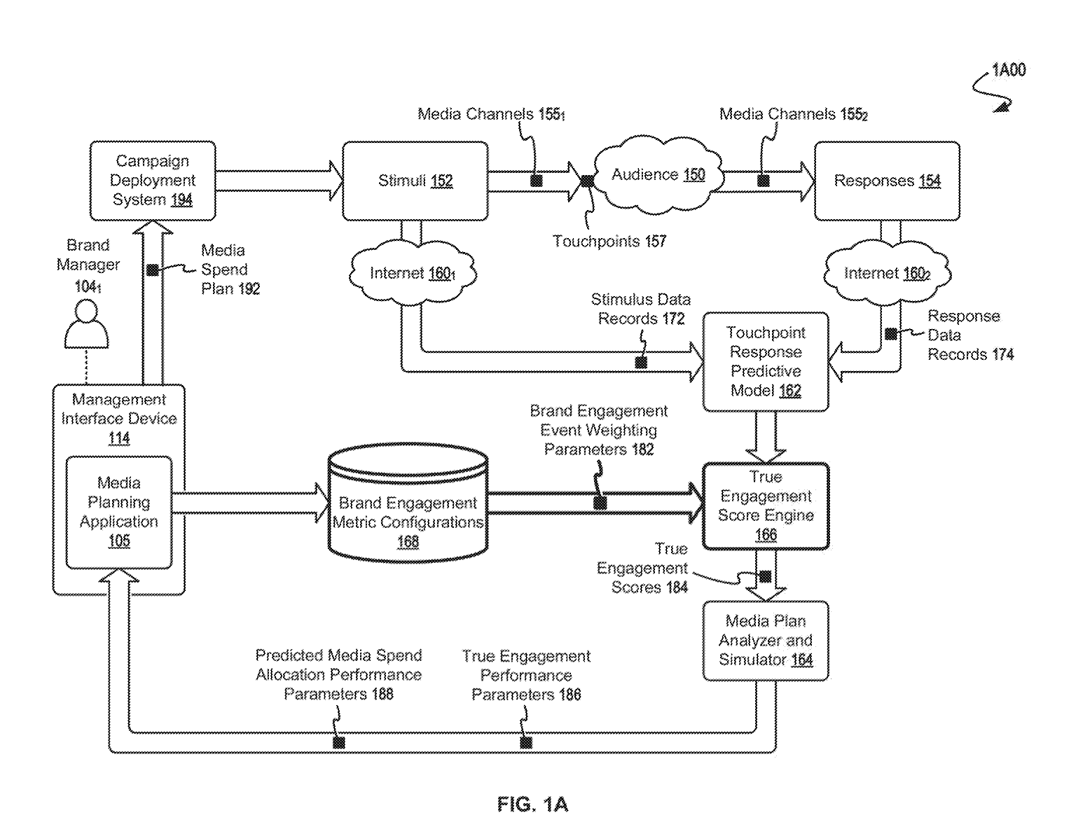

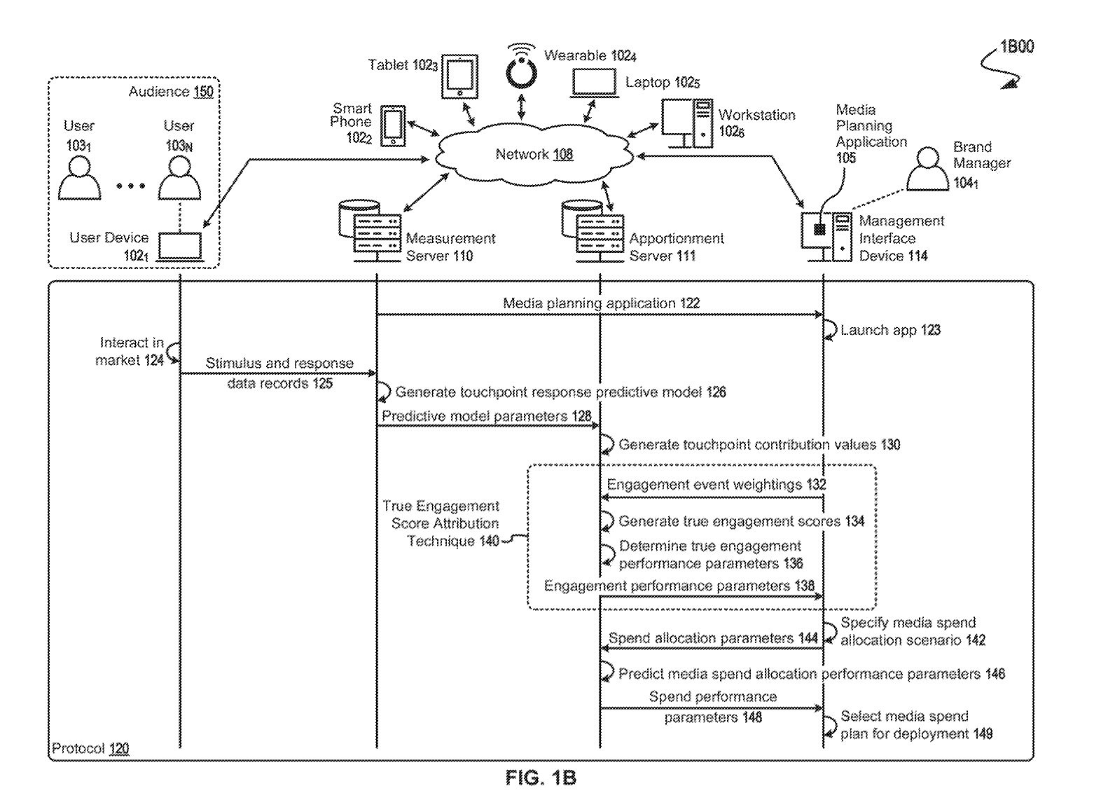

FIG. 1A depicts techniques 1A00 for brand engagement touchpoint attribution using brand engagement weighting. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a marketing campaign) that further produces a set of responses 154. For example, the stimuli 152 might be part of a marketing campaign developed by a brand marketing manager (e.g., brand manager 104₁) to reach the audience 150 with the objective to generate user conversions (e.g., sales of a certain product). The stimuli 152 is delivered to the audience 150 through certain instances of media channels 155) that can comprise digital or online media channels (e.g., online display, online search, paid social media, email, etc.). The media channels 155₁ can farther comprise non-digital or offline media channels (e.g., TV, radio, print, etc.). The audience 150 is exposed to each stimulation comprising the stimuli 152 through a set of touchpoints 157 characterized by certain respective attributes. The responses 154 can also be delivered through other instances of media channels 155₂ that can further comprise online and offline media channels. In some cases, the information indicating a particular response can be included in the attribute data associated with the instance of the touchpoints 157 to which the user is responding. The portion of stimuli 152 delivered through online media channels can be received by the users comprising audience 150 at various instances of user devices (e.g., mobile phone, laptop computer, desktop computer, tablet, etc.). Further, the portion of responses 154 received through digital media channels can also be invoked by the users comprising audience 150 using the user devices.

As further shown, a set of stimulus data records 172 and a set of response data records 174 can be received over a network (e.g., Internet 160₁ and Internet 160₂, respectively) to be used to generate a touchpoint response predictive model 162. The touchpoint response predictive model 162 can be used to estimate the effectiveness of each stimulus in a certain marketing campaign by attributing credit (e.g., contribution value) to the various stimuli comprising the campaign. More specifically, the touchpoint response predictive model 162 can be used to estimate the contribution value that can be attributed to each stimulus and/or group of stimuli (e.g., a channel from the media channels 155₁) in obtaining one or more responses (e.g., conversions, engagement states, etc.) comprising the response data records 174.

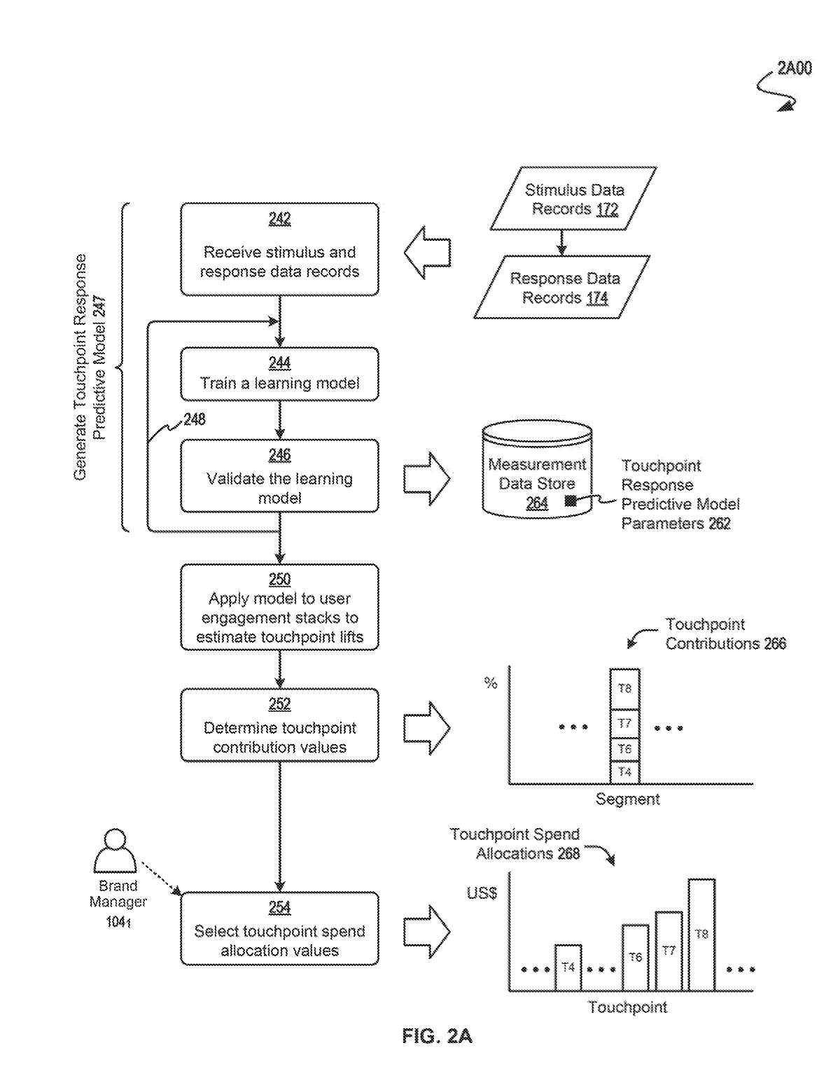

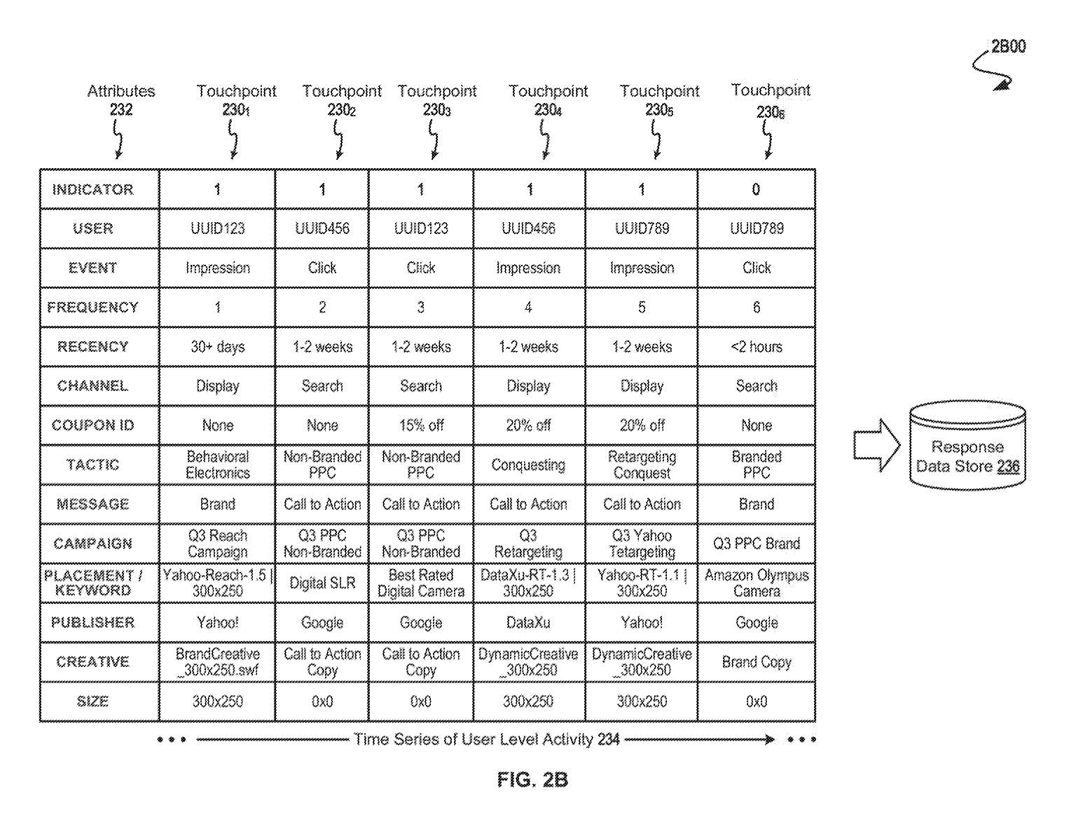

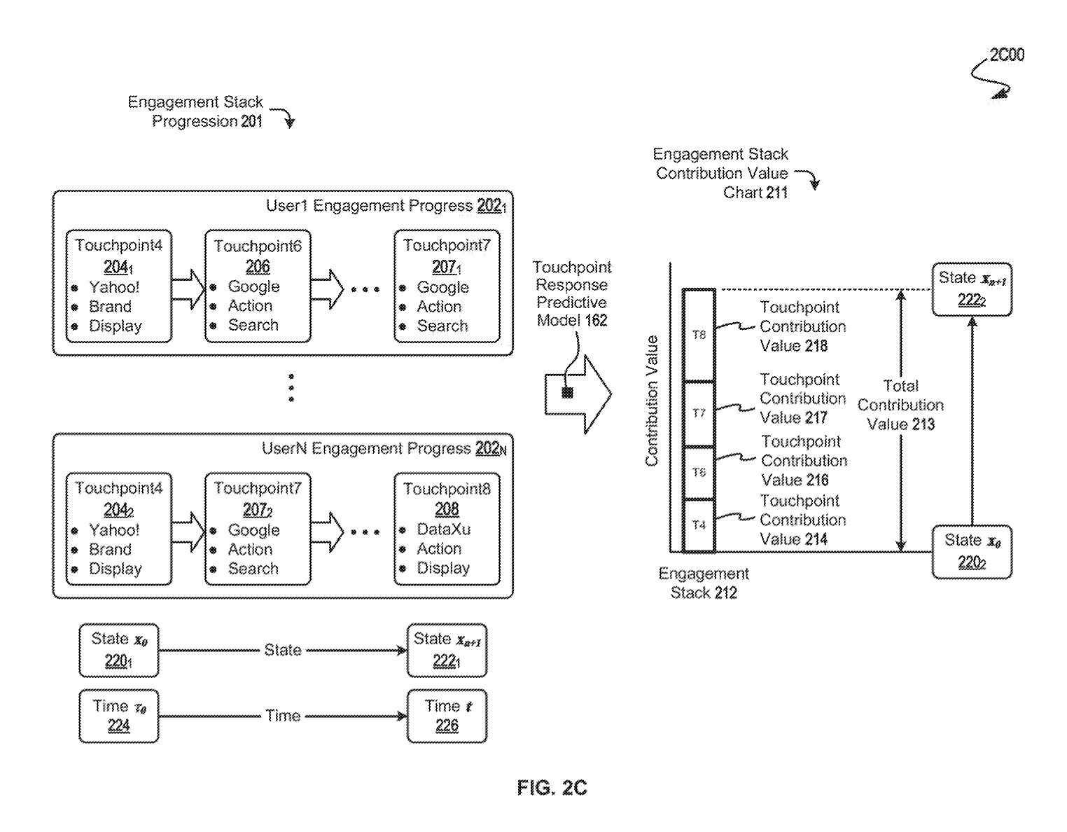

The touchpoint response predictive model 162 can be formed using any machine learning techniques (e.g., see FIG. 2A) to accurately model the relationship between the stimuli 152 and the responses 154. For example, weekly summaries of the stimulus data records 172 and the response data records 174 over a certain historical period (e.g., over the last six months) can be used to generate the touchpoint response predictive model 162. When formed, the touchpoint response predictive model 162 can be described in part by certain model parameters (e.g., input variables, output variables, equations, equation coefficients, mapping relationships, limits, constraints, etc.).

In some cases, the brand manager 104₁ might want to know the effect various touchpoints have on the overall brand engagement of a subject audience. The herein disclosed techniques provide a technological solution for the brand manager 104₁ by providing brand engagement touchpoint attributions (e.g., true engagement scores) using brand engagement event weighting. Specifically, in one or more embodiments, a true engagement score engine 166 can apply a set of brand engagement event weighting parameters 182 to a set of touchpoint contribution values predicted by the touchpoint response predictive model 162 to determine a respective set of weighted touchpoint contribution values.

The weighted touchpoint contribution values are combined across user segments and/or engagement events and/or other dimensions to generate a set of true engagement scores 184 for each touchpoint. In one or more embodiments, the brand engagement event weighting parameters 182 can be derived from a set of brand engagement metric configurations 168 specified by the brand manager 104₁. For example, the brand manager 104₁ might assign a relative weighting to respective brand engagement events (e.g., first-time website visit, whitepaper download, product review, etc.) associated with a brand engagement metric and/or campaign. In other embodiments, the brand engagement event weighting parameters 182 might be determined by the touchpoint response predictive model 162 using historical instances of the stimulus data records 172 and response data records 174.

A media plan analyzer and simulator 164 might be used in combination with the touchpoint response predictive model 162 and the true engagement score engine 166 to facilitate actions taken by the brand manager 104₁ to analyze the performance and/or select a media spend allocation plan for a given brand engagement campaign. For example, the brand manager 104₁ can access the media plan analyzer and simulator 164 using a media planning application 105 operating on a management interface device 114 (e.g., laptop computer) to analyze various brand engagement campaigns and/or various media spend allocation scenarios.

Specifically, the media plan analyzer and simulator 164 can generate a set of true engagement performance parameters 186 that can he rendered by the media planning application 105 to present to the brand manager 104₁ the true engagement scores 184 and associated engagement performance metrics (e.g., user reach, engaged users, conversions, etc.) across all channels (e.g., TV, search, display, social, email, etc.) of a given brand engagement campaign. The brand manager 104₁ might farther use the media plan analyzer and simulator 164 and the media planning application 105 to determine a media spend allocation scenario based in part on the presented engagement performance metrics.

For example, the brand manager 104₁ might allocate a media spend budget among the foregoing channels in an effort to increase tire propensity of the target audience to reach a certain performance level associated with an overall brand engagement metric (e.g., engagement KPI). For a given media spend allocation scenario, the media plan analyzer and simulator 164 can generate a set of predicted media spend allocation performance parameters 188 corresponding to a predicted performance (e.g., engagement level, conversions, ROI, other performance metrics, etc.) of the media spend allocation scenario to he used in presenting such a response and/or performance to the brand manager 104₁ in the media planning application 105. The brand manager 104₁ can compare various media spend allocation scenarios to select a media spend plan 192 for deployment to the audience 150 by a campaign deployment system 194.

FIG. 1B is an environment 1B00 in which embodiments of the present disclosure can operate. As an option, one or more instances of environment 1B00 or any aspect thereof may be implemented in the context of the architecture and functionality of the embodiments described herein. Also, the environment 1B00 or any aspect thereof may be implemented in any desired environment.

As shown in FIG. 1B, the environment 1B00 comprises various comparing systems (e.g., servers and devices) interconnected by a network 108. The network 108 can comprise any combination of a wide area network (e.g., WAN), local area network (e.g., LAN), cellular network, wireless LAN (e.g., WLAN), or any such means for carrying out electronic communications between competing systems. The network 108 can also be referred to as the Internet. More specifically, environment 1B00 comprises at least one instance of a measurement server 110, at least one instance of an apportionment server 111, and at least one instance of a management interface device 114. The servers and devices shown in environment 1B00 can represent any single computing system with dedicated hardware and software, multiple computing systems clustered together (e.g., a server form, a host farm, etc.), a portion of shared resources on. one or more computing systems (e.g., a virtual server), and/or any combination thereof.

The environment 1B00 further comprises at least one instance of a user device 102₁ that can represent one of a variety of other computing de vices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103₁. Other users (e.g., user 103_{N} ) with or without a corresponding user device can comprise the audience 150. Also, as earlier described in FIG. 1A, the media planning application 105 can be operating on the management interface device 114 and accessible by the brand manager 104₁ .

As shown, the user 103₁, the user device 102₁(e.g., operated by user 103_{N}), the measurement server 110, the apportionment server 111, and the management interface device 114 (e.g., operated by the brand manager 104₁) can exhibit a set of high-level interactions (e.g., operations, messages, etc.) in a protocol 120. Specifically, the protocol can represent interactions in systems for implementing brand engagement touchpoint attribution using brand engagement event weighting. As shown, the brand manager 104₁ can download the media planning application 105 from the measurement server 110 to the management interface device 114 (see message 122) and launch the application (see operation 123). Users in audience 150 can also interact with various marketing campaign stimuli delivered through certain media channels (see operation 124), such as taking one or more measureable actions in response to such stimuli and/or other non-media effects.

Information characterizing the stimuli and responses of the audience 150 can be collected as stimulus data records (e.g., stimulus data records 172) and response data records (e.g., response data records 174) by the measurement server 110 (see message 125). Using the stimulus and response data records, the measurement server 110 can generate a touchpoint response predictive model (see operation 126), such as touchpoint response predictive model 162. The model parameters characterizing the touchpoint response predictive model can be availed to the apportionment server 111 (see message 128). The apportionment server 111 can use the touchpoint response predictive model to generate touchpoint contribution values (see operation 130), which values characterize the lift that a respective touchpoint provides to achieving a certain response, such as a certain response associated with an engagement event, a conversion event, and/or another event.

In one or more embodiments, a true engagement score attribution technique 140 might be executed in environment 1B00 as shown. Specifically, the brand manager 104₁ can use the media planning application 105 on the management interface device 114 to specify the weightings of certain engagement events corresponding to one or more brand engagement campaigns (see message 132). The apportionment server 111 can use the weightings and/or other data (e.g., touchpoint contribution values, etc.) to generate the true engagement scores of touchpoints associated with the campaigns (see operation 134). The true engagement scores can be used to determine true engagement performance parameters (see operation 136) that can be availed to the management interface device 114 (see message 138) for analysis by the brand manager 104₁. The brand manager 104₁ can use the engagement performance parameters to specify a media spend allocation scenario for a. given brand engagement campaign (see operation 142). The media spend allocation scenario can be characterized by media spend allocation parameters that can be sent to the apportionment server 111 (see message 144) for simulation (e.g., by the media plan analyzer and simulator 164). Such simulations can produce a set of predicted media spend allocation performance parameters (see operation 146) to be delivered to the management interface device 114 in real time (see message 148) to facilitate actions taken by the brand manager 104₁ to select a media spend plan (e.g., media spend plan 192) for deployment (see operation 149).

As shown in FIG. 1B, the techniques disclosed herein address the problems attendant to estimating the effect that various touchpoints have on the overall brand engagement of a subject audience, in part, by applying the true engagement score attribution technique 140 to the touchpoint contribution values provided b a touchpoint response predictive model (e.g., touchpoint response predictive model 162). More details pertaining to such touchpoint response predictive models are discussed infra.

FIG. 2A presents a touchpoint response predictive modeling technique 2A00 used in systems for brand engagement touchpoint attribution using brand engagement event weighting. As an option, one or more instances of touchpoint response predictive modeling technique 2A00 or any aspect thereof may be implemented in the context of the architecture and functionality of the embodiments described herein. Also, the touchpoint response predictive modeling technique 2A00 or any aspect thereof may be implemented in any desired environment.

FIG. 2A depicts process steps (e.g., touchpoint response predictive modeling technique 2A00) used in the generation of a touchpoint response predictive model (see grouping 247). As shown, stimulus data records 172 and response data records 174 associated with one or more historical marketing campaigns and/or time periods are received by a computing device and/or system (e.g., measurement server 110) over a network (see step 242). The information associated with the stimulus data records 172 and response data records 174 can be organized into various data structures. A portion of the collected stimulus and response data can be used to train a learning model (see step 244). A different portion of the collected stimulus and response data can be used to validate the learning model (see step 246). The processes of training and/or validating can be iterated (see path 248) until the learning model behaves within target tolerances (e.g., with respect to predictive statistic metrics, descriptive statistics, significance tests, etc.).

In some cases, additional historical stimulus and response data can be collected to further train and/or validate the learning model. When the learning model has been generated, a set of touchpoint response predictive mode) parameters 262 (e.g., input variables, output variables, equations, equation coefficients, mapping relationships, limits, constraints, etc.) describing the learning model (e.g., touchpoint response predictive model 162) can be stored in a measurement data store 264 for access by various computing devices (e.g., measurement server 110, management interface device 114, apportionment server 111, etc.).

Specifically, the learning model (e.g., touchpoint response predictive model 162) might be applied to certain user engagement stacks to estimate the touchpoint lifts (see step 250) contributing to conversions, brand engagement events, and/or other events. The contribution value of a given touchpoint can then be determined (see step 252) for a given segment of users and/or media channel. For example, executing step 250 and step 252 might generate a chart showing the touchpoint contributions 266 for a given segment. Specifically, a percentage contribution for a touchpoint4 (“T4”), a touchpoint6 (“T6”), a touchpoint7 (“T7”), and a touchpoint8 (“T8”) can be determined for the segment (e.g., all users, male users, weekend users, California users, etc.).

Further, a brand marketing manager (e.g., brand manager 104₁) can use the touchpoint contributions 266 to further allocate spend among the various touchpoints by selecting associated touchpoint spend allocation values (see step 254). For example, the brand manager 104₁ might apply au overall marketing budget (e.g., in US$) for digital media channels to the various intra-channel touchpoints. In some cases, the brand manager 104₁ can allocate the budget according to the relative touchpoint contributions presented in the touchpoint contributions 266 to produce certain instances of touchpoint spend allocations 268 as shown. In other cases, the touchpoint spend allocations 268 can be automatically generated based on the touchpoint contributions 266. Embodiments of certain data structures used by the touchpoint response predictive modeling technique 2A00 are described in FIG. 2B and FIG. 2C.

FIG. 2B presents a touchpoint attribute chart 2B00 showing sample attributes associated with touchpoints of a media campaign. As an option, one or more instances of touchpoint attribute chart 2B00 or any aspect thereof may be implemented in the context of the architecture and functionality of the embodiments described herein. Also, the touchpoint attribute chart 2B00 or any aspect thereof may be implemented in any desired environment.

As discussed herein, a touchpoint (e.g., touchpoints 157) can be any occurrence where a user interacts with any aspect of a media campaign (e.g., display ad, keyword search, TV ad, etc.). Recording the various stimulation and response touchpoints associated with a marketing campaign can enable certain key performance indicators (KPIs) for the campaign to be determined. For example, touchpoint information might be captured in the stimulus data records 172, the response data records 174, and/or other data records for use by the herein disclosed techniques. Yet, some touchpoints are more readily observed than other touchpoints. Specifically, touchpoints in non-digital media channels might not be observable at a user level and/or an individual transaction level such that summary and/or aggregate responses in non-digital channels are provided. In comparison, touchpoints in digital media channels can be captured in real-time at a user level (e.g., using Internet technology). The attributes of such touchpoints in digital media channels can be structured as depicted in the touchpoint attribute chart 2B00.

Specifically, the touchpoint attribute chart 2B00 shows a plurality of touchpoints (e.g., touchpoint 230₁, touchpoint 230₂, touchpoint 230₃, touchpoint 230₄, touchpoint 230₅, and touchpoint 230₆) that might be collected and stored (e.g., in response data store 236) for various analyses (e.g., at measurement server 110, apportionment server 111, etc.). The example dataset of touchpoint attribute chart 2B00 comprises a time series of user level activity 234 that maps various touchpoints to a respective plurality of attributes 232. For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on. More specifically, and as Indicated by the “Event” attribute, touchpoint 230₁ was an “Impression” presented to the user, while touchpoint 230₂ corresponds to an item (e.g., “Call to Action” for “Digital SLR”) the user responded to with a “Click”. Also, and as represented by the “Indicator” attribute, touchpoint 230₁ was presented in the time window specified by the “Recency” attribute (e.g., “30+ Days”), while touchpoint 230₆ was not presented (e.g., as indicated by a “0”) in the time window specified by the “Recency” attribute (e.g., “<2 hours”).

For example, the “Indicator” can be used to distinguish the touchpoints actually experienced by a user (e.g., comprising the stimulus data records 172) as compared to planned touchpoint stimulus. In some cases, the “Indicator” can be used to identify responses to a given touchpoint (e.g., a “1” indicates the user responded wish a click, download, etc.). Further, as indicated by the “User” attribute, touchpoint 230₁ was presented to a user identified as “UUID123”, while touchpoint 230₂ was presented to a user identified as “UUID456”. The remaining information in the touchpoint attribute chart 2B00 identifies other attribute values for the plurality of touchpoints.

In some cases, the attributes 232 associated with a touchpoint might correspond to the media channel in which the touchpoint is delivered. For example, the touchpoint attribute chart 2B00 might correspond to touchpoints in digital medial channels. In comparison, the touchpoint attributes of touchpoints in a TV media channel might comprise advertiser, network, telecast, program, airing timestamp, day part (e.g., daytime, prime time, early fringe, late fringe, early morning, overnight, etc.), spot length (e.g., 0:15, 0:30, 0:60, etc.), geography, creative, message, ad pod position, (e.g., first, first no promo, middle, last, last no promo, etc.), campaign, cost, and/or other attributes.

A measurable relationship between one or more touchpoints and a progression through engagement and/or readiness states towards a target state is possible. Such a collection of touchpoints contributing to reaching the target state (e.g., conversion, brand engagement, etc.) can be called an engagement stack. Indeed, the foregoing touchpoint response predictive modeling technique 2A00 can be applied to such engagements stacks to determine the contribution values of touchpoints (e.g., touchpoint contributions 266) associated with certain desired responses such as conversion events, brand engagement events, and/or other events. When analyzing the impact of touchpoints on a user's engagement progression, and possible execution of the target response event a time-based progression view of the touchpoints and a stacked engagement contribution value of the touchpoints can be considered as shown in FIG. 2C.

FIG. 2C illustrates a touchpoint attribution technique 2C00 used in systems for brand engagement touchpoint attribution using brand engagement event weighting. As an option, one or more instances of a touchpoint attribution technique 2C00 or any aspect thereof may be implemented in the context of the architecture and functionality of the embodiments described herein. Also, the touchpoint attribution technique 2C00 or any aspect thereof may be implemented in any desired environment.

The touchpoint attribution technique 2C00 illustrates an engagement stack progression 201 that is transformed by the touchpoint response predictive model 162 to an engagement stack contribution value chart 211. Specifically, the engagement stack progression 201 depicts a progression of touchpoints experienced by one or more users. More specifically, a User1 engagement progress 202₁ and a UserN engagement progress 202_{N} are shown as representative of given audience (e.g., comprising User1 . . . , UserN). The User1 engagement progress 202₁ ; and the UserN engagement progress 202_{N} represent the user's progress from a state x₀ 220₁ to a state xₙ₊₁ 222₁ over a time τ₀ 224 to a time t 226.

For example, the state x₀ 220₁ can represent an Initial user engagement state (e.g., no engagement) and the state xₙ₊₁ 222₁ can represent a final user engagement state (e.g., conversion, brand engagement event, etc.). Further, the time from τ₀ 224 to time t 226 can represent a measurement time window for performing touchpoint attribution analyses. As shown in User1 engagement progress 202₁, User1 might experience a touchpoint4 204₁ comprising a branding display creative published by Yahoo!. At some later moment. User1 might experience a touchpoint6 206 comprising Google search results (e.g., search keyword “Digital SLR”) prompting a call to action. At yet another moment later in time, User1 might experience a touchpoint7 207₁ comprising Google search results (e.g., search keyword “Best Rated Digital Camera”) also prompting a call to action. As shown in UserN engagement progress 202_{N}, UserN might experience touchpoint4 204₄ having the same attributes as touchpoint4 204₁. At some later moment, UserN might experience a touchpoint7 207₂ having the same attributes as touchpoint8 207₁. At yet another moment later in time, UserN might experience a touchpoint8 208 comprising a call-to-action display creative published by DataXu. Any number of time-stamped occurrences of these touchpoints and/or additional information pertaining to the touchpoints and/or user responses to the touchpoints (e.g., captured in attributes 232), can be received over the network in real time for use in generating the touchpoint response predictive model 162 and the resulting engagement stack contribution value chart 211.

The engagement stack contribution value chart 211 shows the “stack” of contribution values (e.g., touchpoint contribution value 214, touchpoint contribution value 216, touchpoint contribution value 217, and touchpoint contribution value 218) of the respective touchpoints (e.g., T4, T6, T7, and T8, respectively) of engagement stack 212. The overall contribution value of the encasement stack 212 is defined by a total contribution value 213. Various techniques (e.g., the touch point response predictive modeling technique 2A00) can determine the contribution value from the available touchpoint data (e.g., stimulus data records 172, response data records 174, etc.). As shown, the contribution values indicate a relative contribution (e.g., a lift) a respective touchpoint has on transitioning the subject audience segment from state x₀ 220₂ to state xₙ₊₁ 222₂.

In some cases, a brand marketing manager can use such relative touchpoint contribution values provided by user-level or “bottom-up” attribution models (e.g., touchpoint response predictive model 162) to determine the touchpoint contribution to reaching a certain brand engagement state associated with a given brand engagement event such as a whitepaper download, a product review, an on-site video completion, and/or other brand engagement events. In other cases, the brand marketing manager might want to know the impact certain touchpoints have on an overall brand engagement metric for a subject audience. The herein-disclosed techniques provide a technological solution for the brand marketing manager as described infra.

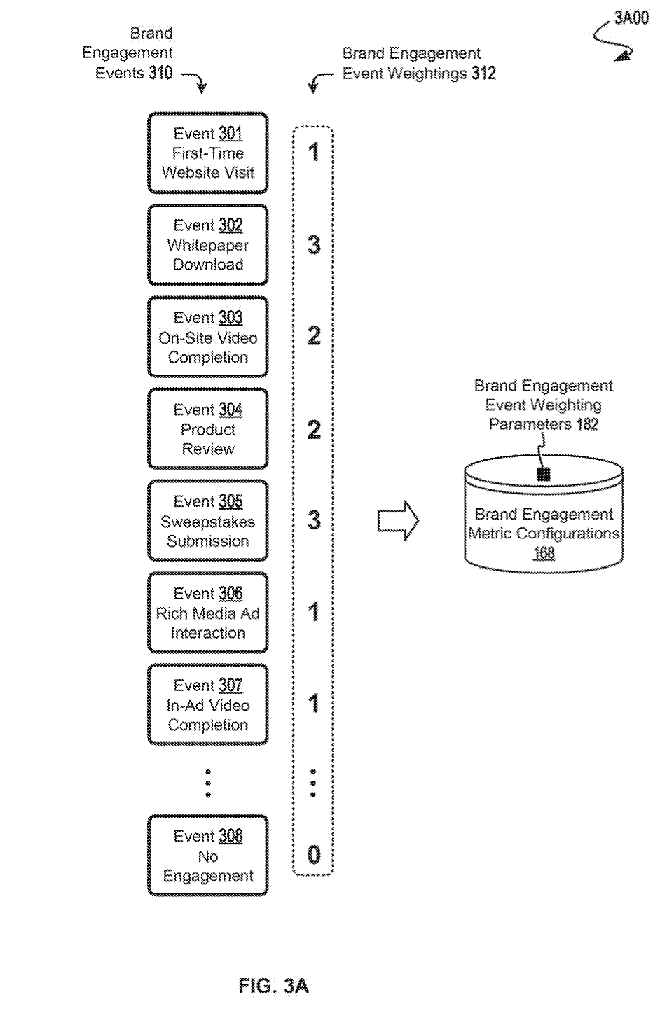

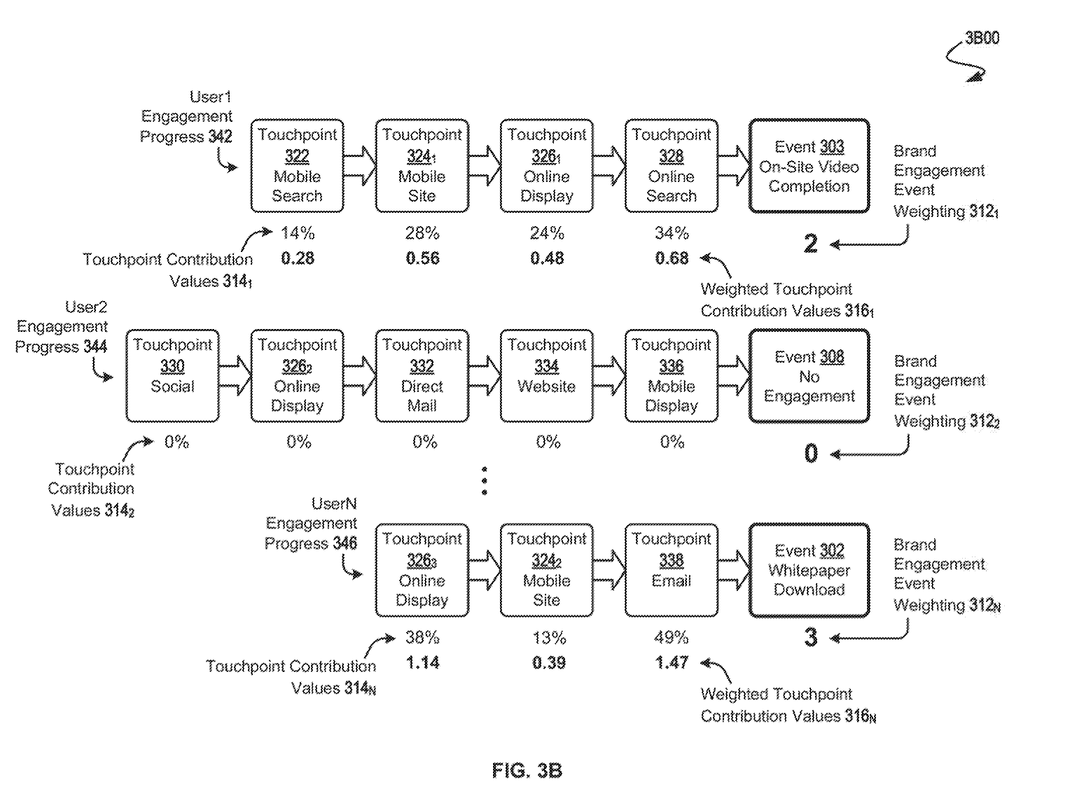

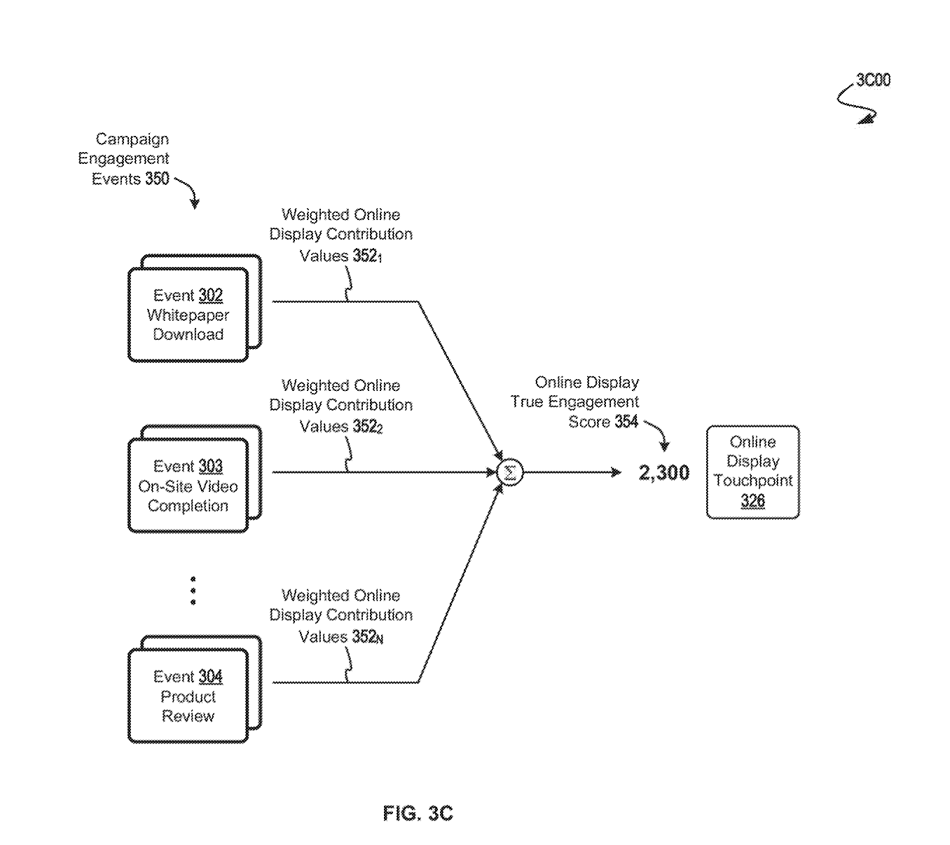

FIG. 3A depicts brand engagement event weighting assignments 3A00 used in systems for brand engagement touchpoint attribution using brand engagement event weighting. As an option, one or more instances of brand engagement event weighting assignments 3A00 or any aspect thereof may be implemented in the context of the architecture and functionality of the embodiments described herein. Also, the brand engagement event weighting assignments 3A00 or any aspect thereof may be implemented in any desired environment.

FIG. 3A depicts a set of brand engagement events 310 (e.g., event 301, event 302, event 303, event 304, event 305, event 306, event 307, . . . , event 308) having a respective relative weighting comprising a set of brand engagement event weightings 312 (e.g., 1, 3, 2, 2, 3, 1, 1 , . . . , 0, respectively). For example, the brand engagement events 310 might comprise the events considered relevant to a brand marketing manager for a given brand engagement campaign. In some cases, the brand marketing manager might consider one event a better indicator of a given overall brand engagement metric (e.g., engagement KPI) as compared to another event, and assign a weighting to the events accordingly. For example, and as shown, the event 302 (e.g., whitepaper download) might be considered a better indicator of an overall brand engagement metric and assigned a weighting of 3, while the event 306 (e.g., engaging in rich media ad interaction) is considered less of an indicator and assigned a weighting of 1. In one or more embodiments, the brand engagement event weightings 312 can be specified by the brand marketing manager. In some embodiments, such assigned weightings can be codified in the brand engagement event weighting parameters 182 (e.g., as key-value pairs) and stored as instances of brand engagement metric configurations 168.

FIG. 3B presents a touchpoint contribution value weighting technique 3B00 used in systems for brand engagement touchpoint attribution using brand engagement event weighting. As an option, one or more instances of touchpoint contribution value weighting technique 3B00 or any aspect thereof may be implemented in the context of the architecture and functionality of the embodiments described herein. Also, the touchpoint contribution value weighting technique 3B00 or any aspect thereof may be implemented in any desired environment.

The touchpoint contribution value-weighting technique 3B00 shown in FIG. 3B comprises three representative instances of user engagement progressions through various touchpoints to reach a given brand engagement event. Specifically, a User1 engagement progress 342 represents the sequence of touchpoints (e.g., touchpoint 322, touchpoint 324₁, touchpoint 326₁, touchpoint 328) experienced by User1 before reaching a certain engagement event (e.g., event 303 pertaining to watching a video to completion). Also shown is a User2 engagement progress 344 representing the sequence of touchpoints (e.g., touchpoint 330, touchpoint 326₂, touchpoint 332, touchpoint 334, touchpoint 336) experienced by User2 before reaching a certain engagement event (e.g., event 308). Further, a UserN engagement progress 346 represents the sequence of touchpoints (e.g., touchpoint 326₃, touchpoint 324₂, touchpoint 338) experienced by UserN before reaching a certain engagement event, (e.g., event 302). As shown, a set of touchpoint contribution values (e.g., touchpoint contribution values 314₁, touchpoint contribution values 314₂, . . . , touchpoint contribution values 314_{N}) can be determined (e.g., using the touchpoint response predictive modeling technique 2A00) for the touchpoints comprising the user engagement progressions. For example, touchpoint 326₁ (e.g., online display) might, have a contribution value of 24% for User1 in reaching event 303 (e.g., on-site video completion), yet touchpoint 326₃ having the same attributes as touchpoint 326₁ might have a contribution value of 38% for UserN in achieving or reaching up to event 302 (e.g., whitepaper download). In comparison, touchpoint 326₂ having the same attributes as touchpoint 326₁ and touchpoint 326₃ might have a contribution value of 0% for User2 since no engagement event (e.g., event 308) was reached.

Using the touchpoint contribution value weighting technique 3B00 and other herein disclosed techniques, certain brand engagement event weightings (e.g., brand engagement event weighting 312₁, brand engagement event weighting 312₂, . . . , brand engagement event weighting 312_{N}) can be applied to the touchpoint contribution values to generate a set of weighted touchpoint contribution values (e.g., weighted touchpoint contribution values 316₁, . . . , weighted touchpoint contribution values 316_{N}). For example, in one or more embodiments, the touchpoint contribution value of touchpoint 322 (e.g., 14%) associated with event 303 can be multiplied by the brand engagement event weighting 312₁ of event 303 (e.g., 2) to determine the weighted touchpoint contribution, value of touchpoint 322 (e.g., 0.28). In one or more embodiments, the herein disclosed techniques can use the weighted touchpoint contribution values associated with multiple engagement events in a brand engagement campaign to determine a true engagement score for a given touchpoint as discussed in FIG. 3C.

FIG. 3C illustrates a true engagement score generation technique 3C00 used in systems for brand engagement touchpoint attribution using brand engagement event weighting. As an option, one or more instances of a true engagement score generation technique 3C00 or any aspect thereof may be implemented in the context of the architecture and functionality of the embodiments described herein. Also, the true engagement score generation technique 3C00 or any aspect thereof may be implemented in any desired environment.

Specifically, the true engagement score generation technique 3C00 uses a set of all of the campaign engagement events 350 associated with a certain brand marketing campaign to determine the true engagement score for one or more touchpoints. More specifically, and as shown, the campaign engagement events 350 can comprise the brand engagement events experienced by the target audience (e.g., multiple instances of event 302, multiple instances of event 303, . . . , multiple instances of event 304). As described in the touchpoint contribution value weighting technique 3B00, weighted touchpoint contribution values associated with respective touchpoints comprising the user engagement progressions leading up to each engagement event can be determined. For example, for an online display touchpoint 326, the touchpoint contribution value weighting technique 3B00 can provide multiple instances of weighted online display contribution values (e.g., weighted online display contribution values 352₁ weighted online display contribution values 352₂, . . . , weighted online display contribution values 352_{N}) for each online display touchpoint in the campaign engagement events 350 (e.g., touchpoint 326₁, touchpoint 326₂, touchpoint 326₃, etc. shown in FIG. 3B). As shown, such weighted online display contribution values can be combined according to the true engagement score generation technique 3C00 to generate an online display true engagement score 354 (e.g., 2,300). The acts of combining weighted contribution values (e.g., weighted online display contribution values) can include generating a sum (e.g., using an additive arithmetic operator) and/or generating a product (e.g., using a multiplicative arithmetic operator).

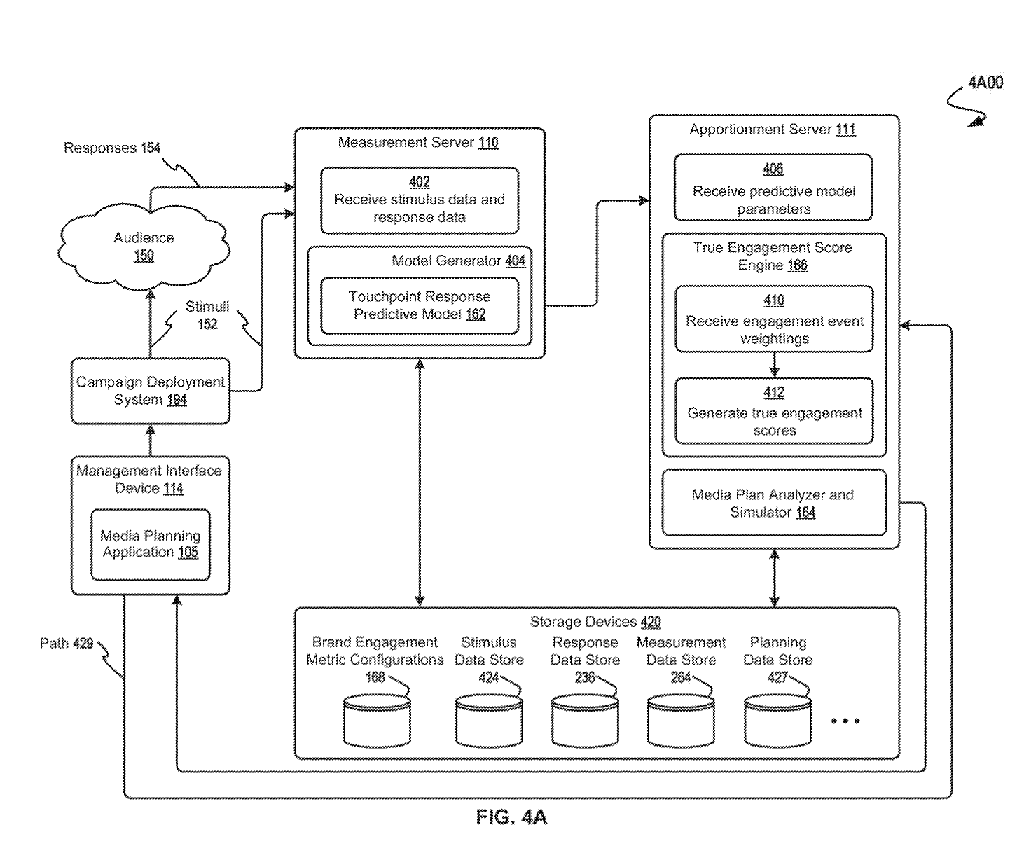

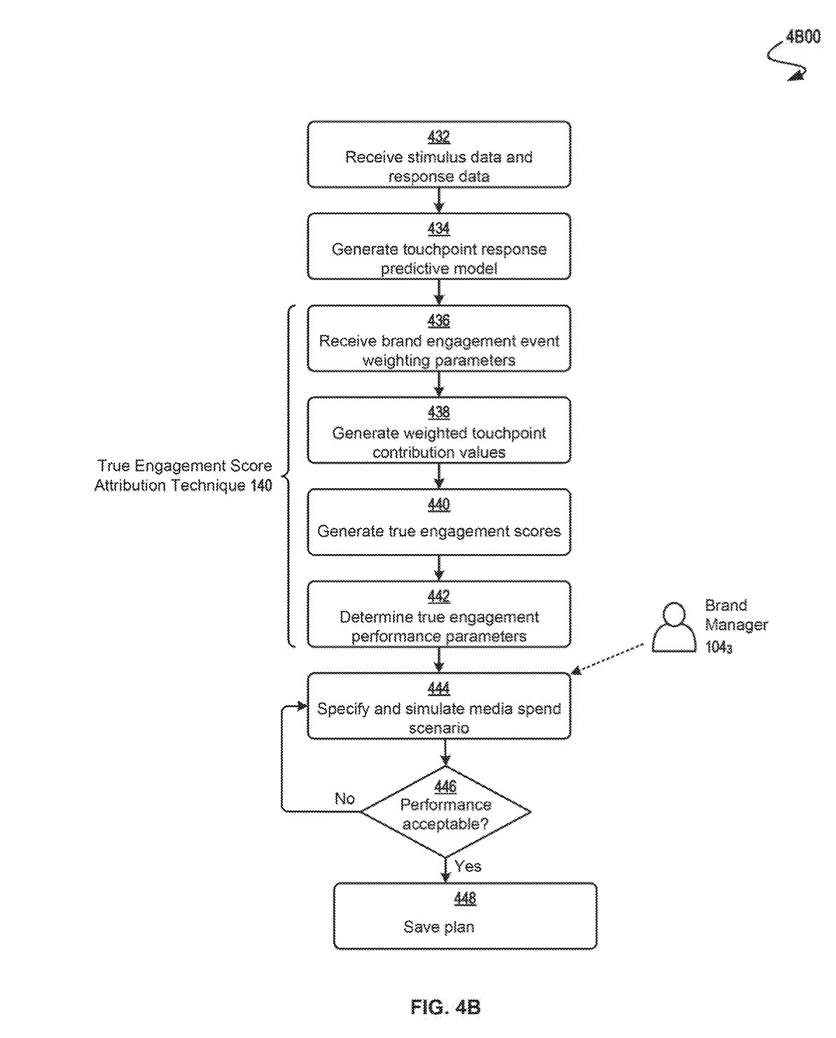

FIG. 4A depicts a subsystem 4A00 for determining brand engagement touchpoint attributions using brand engagement event weighting. As an option, one or more instances of subsystem 4A00 or any aspect thereof may be implemented in the context of the architecture and functionality of the embodiments described herein. Also, the subsystem 4A00 or any aspect, thereof may be implemented in any desired environment.

As shown, subsystem 4A00 comprises certain components described in FIG. 1A and FIG. 1B. Specifically, the campaign deployment system 194 can present the stimuli 152 to the audience 150 to produce the responses 154. The measurement server 110 can receive electronic data records associated with the stimuli 152 and responses 154 (see operation 402). The stimulus data and response data can be stored in one or more storage devices 420 (e.g., stimulus data store 424, response data store 236, etc.). The measurement server 110 further comprises a model generator 404 that can use the stimulus data, response data, and/or other data to generate the touchpoint response predictive model 162. In some embodiments, the model parameters (e.g., touchpoint response predictive model parameters 262 shown in FIG. 2A) characterizing the touchpoint response predictive model 162 can be stored in the measurement data store 264.

As shown, the apportionment server 111 can receive the model parameters characterizing the touchpoint response predictive model 162 from the measurement server 110 (see operation 406). The true engagement score engine 166 operating at the apportionment server 111 can further receive engagement event weightings (see operation 410). For example, a user (e.g., brand marketing manager) might interact with the media planning application 105 on the management interface device 114 to specify and transmit brand engagement event weighting parameters (e.g., brand engagement event weighting parameters 182 shown in FIG. 1A) to the apportionment server 111 over path 429.

The true engagement score engine 166 can use the model parameters and/or the engagement event weightings to generate true engagement scores for one or more touchpoints in a brand marketing campaign (see operation 412). The media plan analyzer and simulator 164 at the apportionment server 111 can use the true engagement scores and/or other information to facilitate actions taken by the brand marketing manager to perform various interactions and/or operations at the media planning application 105. For example, the media plan analyzer and simulator 164 can enable an analysis of the true engagement scores and/or related metrics, a prediction of the performance of a media spend allocation scenario based on the true engagement scores, and/or other operations. In one or more embodiments, the data representing the predicted media spend allocation scenario performance (e.g., predicted media spend allocation performance parameters 188 shown in FIG. 1A) can be stored in a planning data store 427.

The subsystem 4A00 presents merely one partitioning. The specific example shown where the measurement server 110 comprises the model generator 404, and where the apportionment server 111 comprises the true engagement score engine 166 and the media plan analyzer and simulator 164 is purely exemplary, and other partitioning is reasonable, and the partitioning may be defined in part by the volume of empirical data. In some cases, a database engine can serve to perform calculations (e.g., within, or in conjunction with a database engine query). A technique for brand engagement touchpoint attribution using brand engagement event weighting implemented in such systems, subsystems, and partitioning is shown in FIG. 4B.

FIG. 4B is a flowchart 4B00 for determining brand engagement touchpoint attribution using brand engagement event weighting. As an option, one or more instances of flowchart 4B00 or any aspect thereof may be implemented in the context of the architecture and functionality of the embodiments described herein. Also, the flowchart 4B00 or any aspect thereof may be implemented in any desired environment.

The flowchart 4B00 presents one embodiment of certain steps for determining brand engagement touchpoint attribution using brand engagement event weighting. In one or more embodiments, the steps and underlying operations shown in the flowchart 4B00 can be executed by the measurement server 110 and apportionment server 111 disclosed herein. As shown, the flowchart 4B00 can commence with receiving stimulus data and response data from various sources (see step 432), such as the stimulus data store 424 and/or the response data store 236. Using the aforementioned received data and/or other data, a touchpoint response predictive model (e.g., touchpoint response predictive model 162) can be generated (see step 434).

The flowchart 4B00 can continue with a set of steps associated with the true engagement score attribution technique 140 (see grouping). Specifically, a set of brand engagement event weighting parameters might be received (see step 436) to be used in generating various weighted touchpoint contribution values (see step 438). The weighted touchpoint contribution values can further be used to generate a set of true engagement scores associated with certain touchpoints (see step 440). Using such true engagement scores and/or other data, various true engagement performance parameters can be determined (see step 442). For example, a brand manager 104₃ might use the true engagement scores and/or true engagement performance parameters to specify and simulate a media spend allocation scenario (see step 444). If the predicted performance values (e.g., number of users reaching a defined engagement level) of the media spend allocation scenario is not acceptable (see “No” path of decision 446), an adjusted set of media spend allocations can be specified (e.g., by the brand manager 104₃) and simulated. When the predicted performance values for the media spend allocation scenario is acceptable (see “Yes” path of decision 446), the accepted media spend allocation scenario can be saved as a media spend plan for immediate and/or future deployment (see step 448).

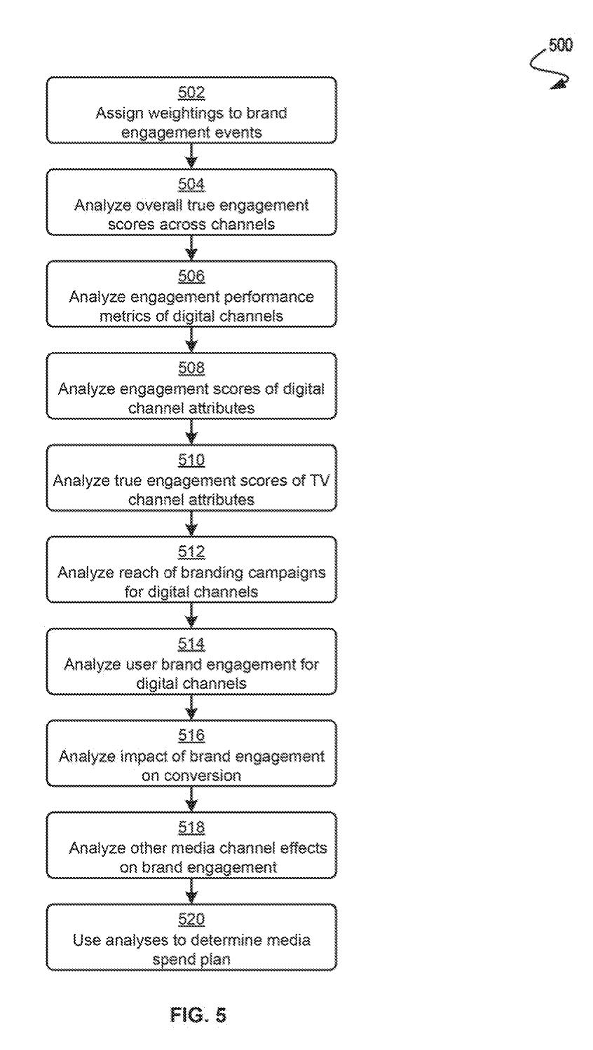

FIG. 5 is a use model flow 500 used in systems for brand engagement touchpoint attribution using brand engagement event weighting. As an option, one or more instances of use model flow 500 or any aspect thereof may be implemented in the context of the architecture and functionality of the embodiments described herein. Also, the use model flow 500 or any aspect thereof may be implemented in any desired environment.

The use model flow 500 presents one embodiment of certain interactions a user (e.g., brand marketing manager) might have with systems for brand engagement touchpoint attribution using brand engagement event weighting. Specifically, and as shown in the use model flow 500, a user might perform the following activities in interacting with such herein disclosed systems:
Assign weightings to brand engagement events (see step 502);
Analyze overall true engagement scores across channels (see step 504);
Analyze engagement performance metrics of digital channels (see step 506);
Analyze true engagement scores of digital channel attributes (see step 508);
Analyze true engagement scores of TV channel attributes (see step 510);
Analyze reach of branding campaigns for digital channels (see step 512);
Analyze user brand engagement for digital channels (see step 514);
Analyze impact of brand engagement on conversion (see step 516);
Analyze other media channel effects on brand engagement (see step 518); and
Use analyses to determine media spend plan (see step 520).

In one or more embodiments, the foregoing user interactions and/or other user interactions might use one or more of the user interfaces described herein.

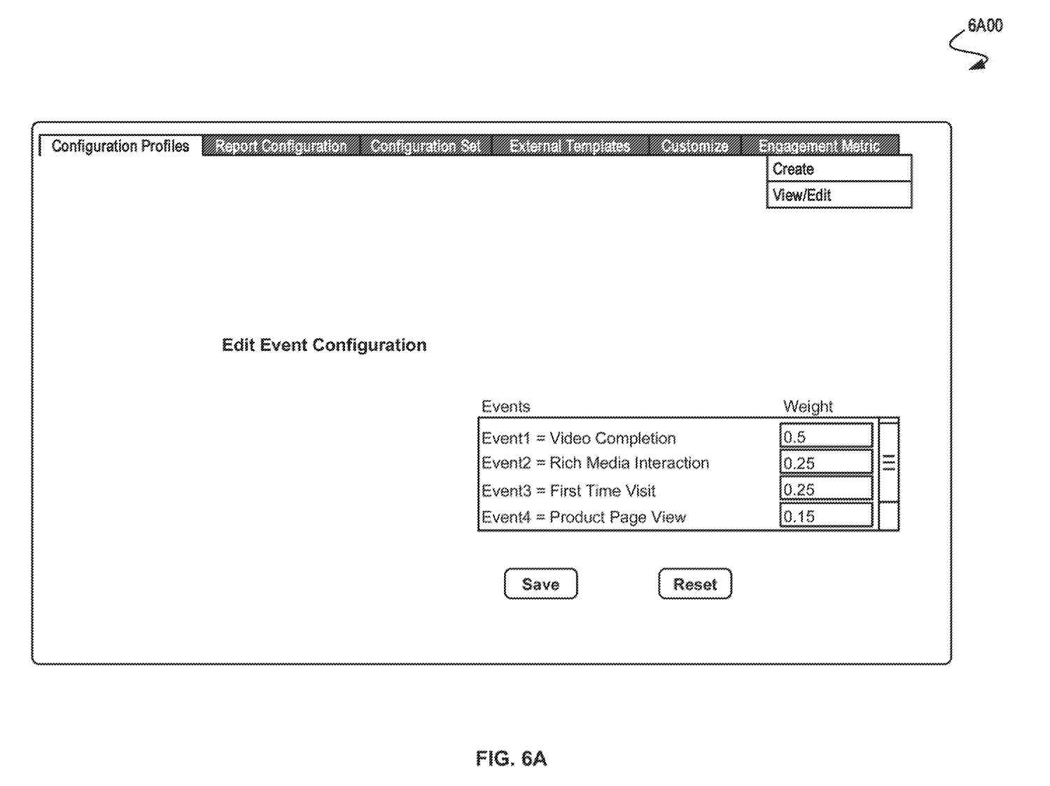

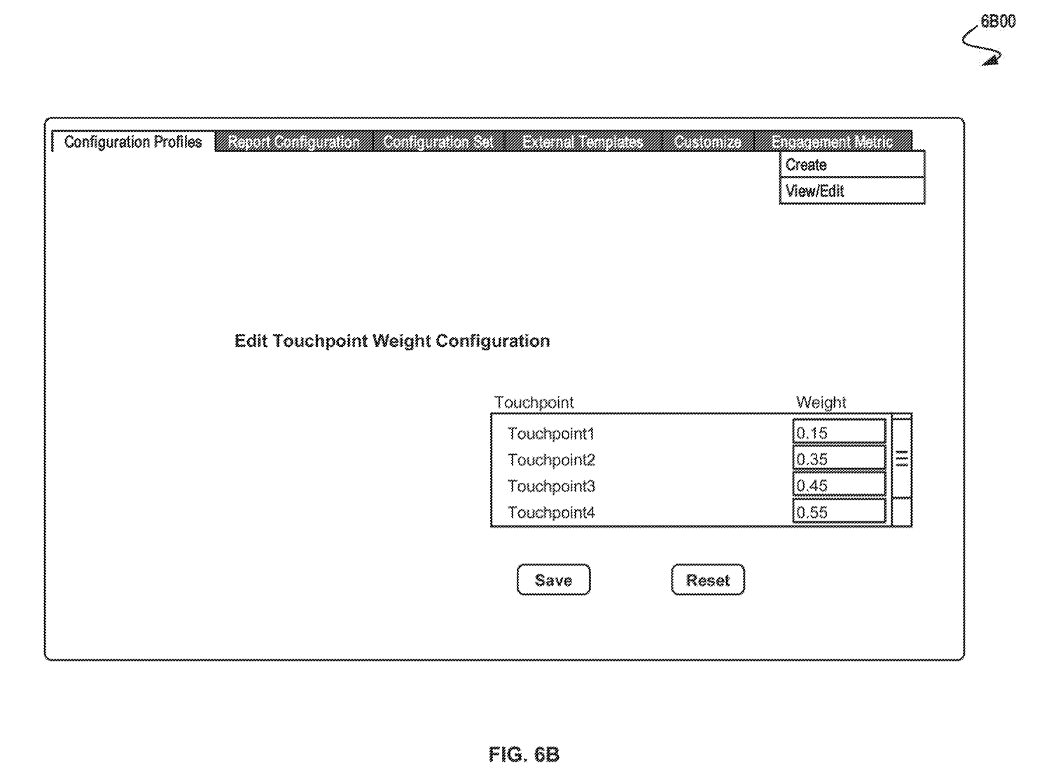

FIG. 6A presents a brand engagement event configuration interface 6A00 for use in systems for brand engagement touchpoint attribution using brand engagement event weighting. As an option, one or more instances of brand engagement event configuration interface 6A00 or any aspect t hereof may be implemented in the context of the architecture and functionality of the embodiments described herein. Also, the brand engagement event configuration interface 6A00 or any aspect thereof may be implemented in any desired environment.

In one or more embodiments, the brand engagement event configuration interface 6A00 can enable a user (e.g., brand marketing manager) to specify a set of brand engagement metric configurations (e.g., brand engagement metric configurations 168) associated with one or more brand marketing campaigns. For example, the user can use the brand engagement event configuration interface 6A00 to assign a weight to one or more engagement events (e.g., Event1, Event2, Event3, Event4). An event may correspond to a particular engagement metric.

FIG. 6B presents a media channel engagement performance interface 6B00 for use in systems for brand engagement touchpoint attribution using brand engagement event weighting. As an option, one or more instances of media channel engagement performance interface 6B00 or any aspect thereof may fee implemented in the context of the architecture and functionality of the embodiments described herein. Also, the media channel engagement performance interface 6B00 or any aspect thereof may be implemented in any desired environment.

In one or more embodiments, the media channel engagement performance interface 6B00 can enable a user (e.g., a brand marketing manager) to analyze the overall true engagement scores across various media channels associated with one or more brand marketing campaigns. For example, the user can analyze the true engagement score and related metrics (e.g., number of Impressions, true engagement rate, etc.) of certain offline and online channels (e.g., T.V., paid search, display, social email, etc.) over time. For example, the user can use the media channel engagement performance interface 6B00 to assign a weight to one or more touchpoints (e.g., Touchpoint1, Touchpoint2, Touchpoint3, Touchpoint4). A touchpoint weight may correspond to a particular engagement metric.

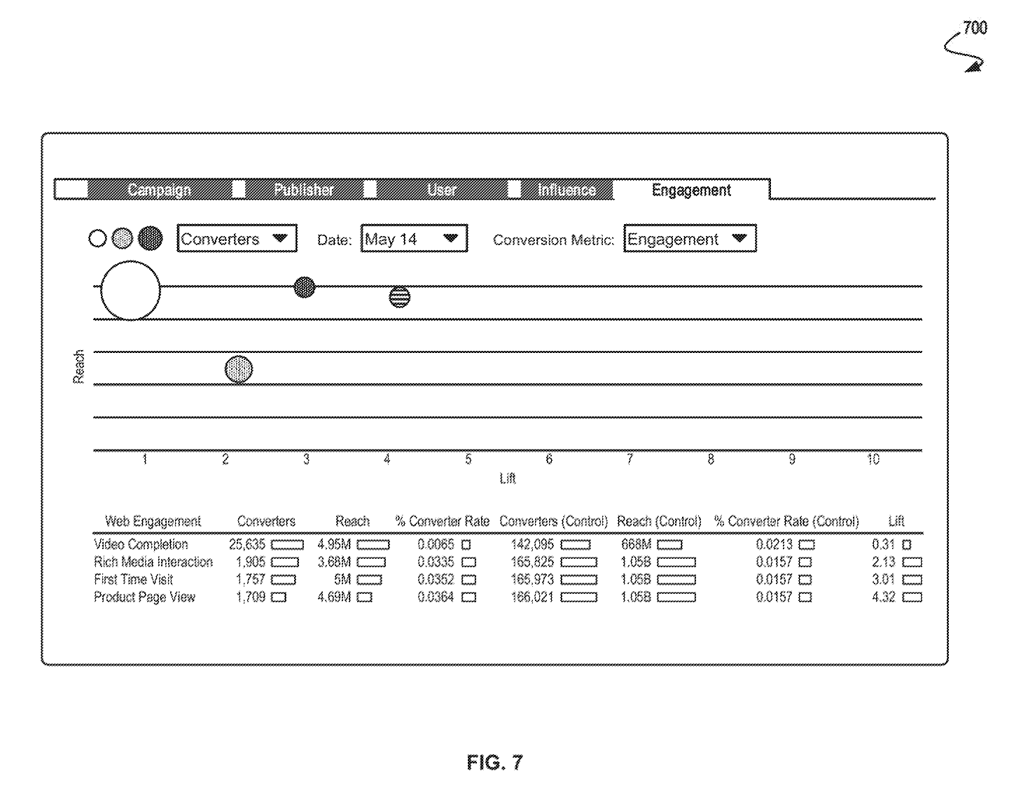

FIG. 7 presents a digital channel conversion impact interface 700 for use in systems for brand engagement touchpoint attribution using brand engagement event weighting. As an option, one or more instances of digital channel conversion impact interface 700 or any aspect thereof may be implemented in the context of the architecture and functionality of the embodiments described herein. Also, the digital channel conversion impact interface 700 or any aspect thereof may be implemented in any desired environment.

In one or more embodiments, the digital channel conversion impact interface 700 can enable a user (e.g., brand marketing manager) to analyze the impact of various engagement events on conversions. For example, for a given engagement event (e.g., web engagement such as video completion, rich media interaction, etc.), various conversion metrics can be presented such as the number of converters, the reach, the percent converter rate, conversion lift, and/or other metrics. In some cases, control and/or base versions of certain metrics can be presented for comparison.

Other user interfaces are possible, and in some cases aspects of a marketing campaign are interrelated and presented graphically. Strictly as an example, in one or more embodiments, a user can compare the reach and/or engagement rate of various campaigns (e.g., corporate social, new product launch, brand awareness). The user might also compare the response to various engagement events (e.g., first-time visitors, store locator, newsletter signups). As another example, for a given time period, the user can view the metrics associated with total reach of branding channels, the total engaged users (e.g., users that invoked at least one brand engagement event), the total reach of direct response channels, the total converters (e.g., users that invoked at least one conversion event), and/or other metrics. As another example, the user can compare the measured reach and frequency associated with a certain digital channel (e.g., display) to related goals over a specified time period.

As yet another example, the user can compare the measured total reach, unique reach, and/or duplicated reach for various publishers used in a given campaign. The ad cost per thousand .impressions (CPM) at each publisher might further be presented by the digital channel publisher performance interface. As even yet another example, for a given target audience and time period, various user engagement metrics might be presented such as average frequency, average cost per engagement (CPE), top engagement types (e.g., based on true engagement scores, true engagement rates, true CPE), top sites (e.g., publisher sites), demographic response (e.g., by age group), and/or other metrics.

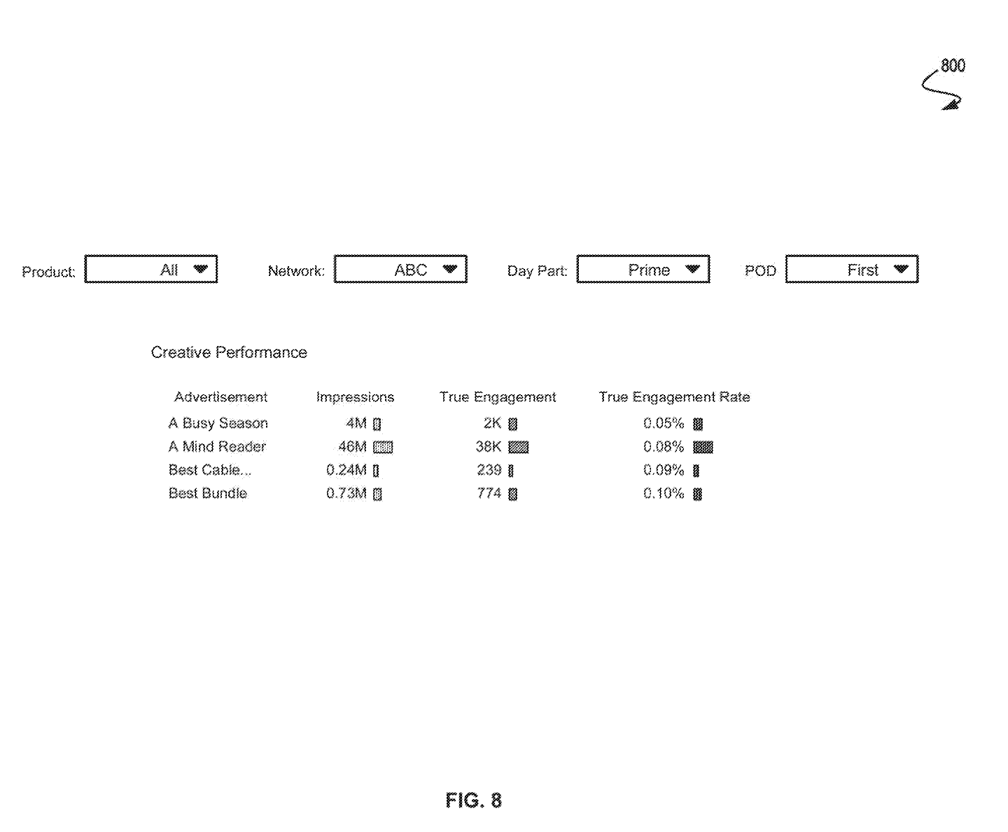

FIG. 8 presents a broadcast network spot performance interface 800 for use in systems for brand engagement touchpoint attribution using brand engagement event weighting. As an option, one or more instances of broadcast network spot performance interface 800 or any aspect thereof may be implemented in the context of the architecture and functionality of the embodiments described herein. Also, the broadcast network spot performance interface 800 or any aspect thereof may be implemented in any desired environment.

In one or more embodiments, the broadcast network spot performance interface 800 can enable a user (e.g., brand marketing manager) to analyze various broadcast media network performance metrics at a granular level. For example, for a given network, the user can compare the performance (e.g., number of impressions, number of true engagements, etc.) during various telecasts (e.g., “60 Minutes”, “Big Brother”, etc.); the performance (e.g., number of impressions, number of true engagements, true engagement rate, etc.) of various creatives (e.g., “A Busy Season”, “A Mind Reader”, etc,); the performance (e.g., number of impressions, number of true engagements, etc.) of various presentation positions (e.g., first, first no promo, last no promo, middle, etc.); the performance (e.g., number of impressions, true engagement rate, etc.) by product of various day parts (e.g., prime, daytime, early fringe, etc.); and/or other performance metrics.

Other techniques to present performance metrics in a graphical form are possible. Strictly as an example, a broadcast media campaign engagement performance interface can enable a user (e.g., brand marketing manager) to analyze various broadcast media engagement performance metrics associated with one or more brand marketing campaigns. For example, the user can compare the reach, the number of impression, and/or the engagement rate of various networks (e.g., ESPN, ABC, CBS, NBC, TBS, etc.). The user might also compare the performance (e.g., reach, engagement rate, etc.) of various schedule day parts across ail networks.

In another embodiment, a broadcast media network performance interface can enable a user (e.g., brand marketing manager) to analyze various broadcast media network performance metrics associated with one or more brand marketing campaigns. For example, for a given time period, the user can compare network performance in terms of the number of impressions, the true engagement rate, and/or other metrics. Certain measured engagement results (e.g., overall, number of impressions, overall true engagement rate, number of impressions by product, true engagement rate by product, etc.) for various schedule day parts across all networks might also be presented. Further, performance metrics (e.g., time engagement rate) for various spot lengths (e.g., 15 seconds 30 seconds, 60 seconds) can be presented.

In still other embodiments, a broadcast network geographical performance interface can enable a user (e.g., brand marketing manager) to analyze various broadcast media network performance metrics across various geographies. For example, for a given network and time period, the user can compare certain metrics (e.g., number of impressions) across states, counties, and/or other geographical regions.

### Additional Practical Application Examples

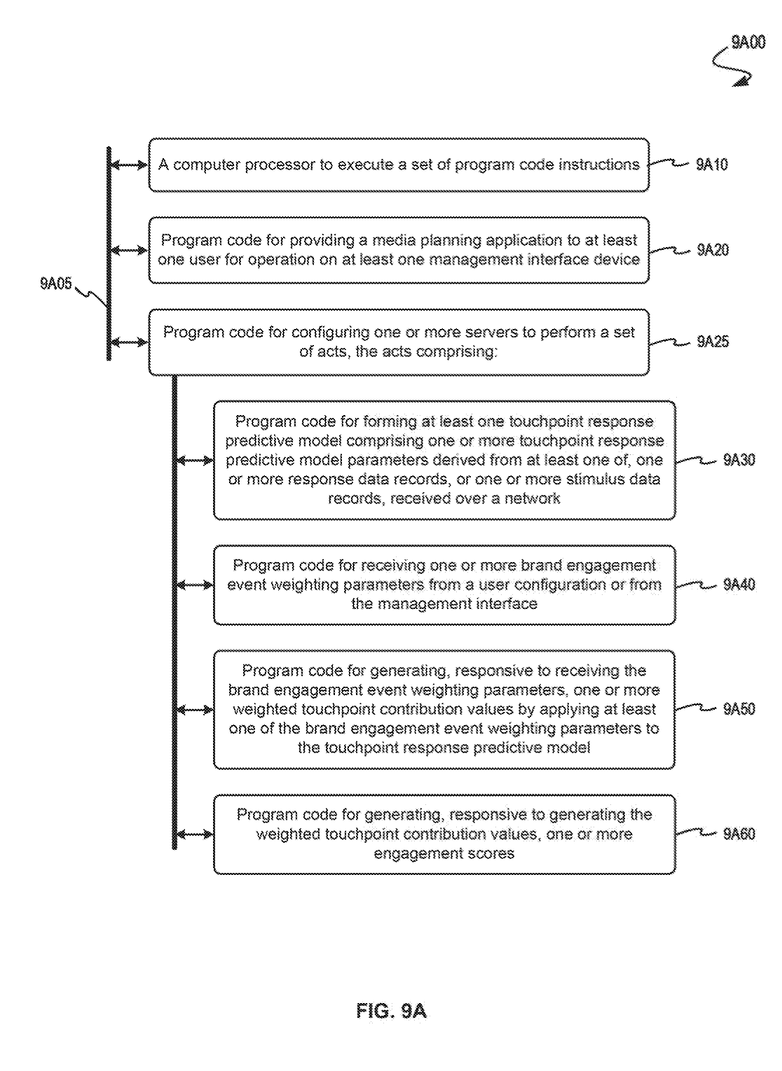

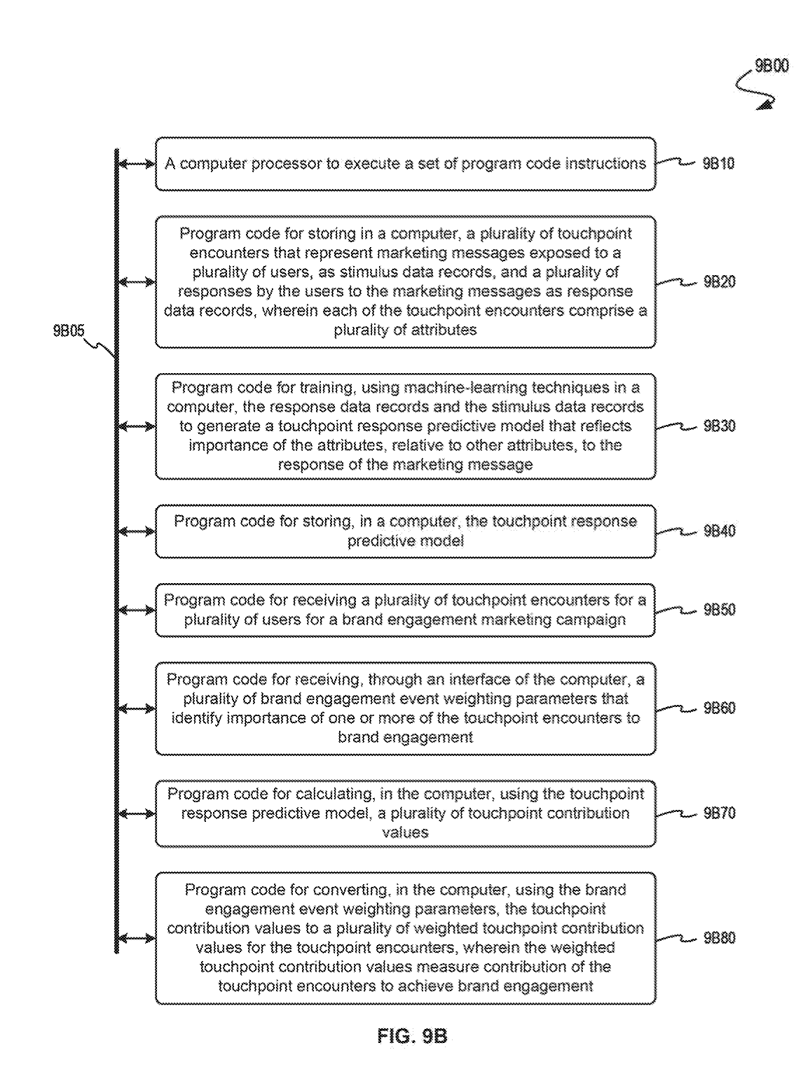

FIG. 9A is a block diagram of a system for brand engagement touchpoint attribution using brand engagement event weighting, according to an embodiment. As an option, the present system 9A00 may be implemented in the context of the architecture and functionality of the embodiments described herein. Of course, however, the system 9A00 or any operation therein may be carried out in any desired environment.

The system 9A00 comprises at least one processor and at least one memory, the memory serving to store program instructions corresponding to the operations of the system. As shown, an operation can be implemented in whole or in part using program instructions accessible by a module. The modules are connected to a communication path 9A05, and any operation can communicate with other operations over communication path 9A05. The modules of the system can. individually or in combination, perform method operations within system 9A00. Any operations performed within system MOO may be performed in any order unless as may be specified in the claims.

The shown embodiment implements a portion of a computer system, presented as system 9A00, comprising a computer processor to execute a set of program code instructions (see module 9A10) and modules for accessing memory to hold program code instructions to perform: providing a media planning application to at least one user for operation on at least one management interface device (see module 9A20); configuring one or more servers to perform a set of acts, the acts comprising (see module 9A25):
forming at least one touchpoint response predictive model comprising one or more touchpoint response predictive model parameters derived from at least one of, one or more response data records, or one or more stimulus data records, received over a network (see module 9A30);
receiving one or more brand engagement event weighting parameters from a user configuration or from the management interface (see module 9A40);
generating, responsive to receiving the brand engagement event weighting parameters, one or more weighted touchpoint contribution values by applying at least one of the brand engagement event weighting parameters to the touchpoint response predictive model (see module 9A50); and
generating, responsive to generating the weighted touchpoint contribution values, one or more engagement scores (see module 9A60).

Other embodiments perform additional acts and/or introduce additional limitations, such as:
Generating one or more engagement performance parameters based at least in part on the engagement scores;
Presenting the engagement performance parameters in the media planning application for analysis by the user;
Generating one or more predicted media spend allocation performance parameters based at least in part on the engagement scores;
Presenting the predicted media spend allocation performance parameter's in the media planning application to allow the user to select at least one media spend plan;
Using brand engagement event weighting parameters that are derived from one or more user con figurations that codify brand engagement metric configurations; and/or
Using brand engagement event weighting parameters that comprise one or more brand engagement event weightings associated with a respective one or more brand engagement events.

FIG. 9B is a block diagram of a system for brand engagement touchpoint attribution using brand engagement event weighting, according to an embodiment. As an option, the system 9B00 may be implemented in the context of the architecture and functionality of the embodiments described herein. Of course, however, the system 9B00 or any operation therein may be carried out in any desired environment.

The system 9B00 comprises at least one processor and at least one memory, the memory serving to store program instructions corresponding to the operations of the system. As shown, an operation can be implemented in whole or in part using program instructions accessible by a module. The modules are connected to a communication path 9B05, and any operation can communicate with other operations over communication path 9B05. The modules of the system can, individually or in combination, perform method operations within system 9B00. Any operations performed within system 9B00 may be performed in any order unless as maybe specified in the claims.

The shown embodiment implements a portion of a computer system, presented as system 9B00, comprising a computer processor to execute a set of program code instructions (see module 9B10) and modules for accessing memory to hold program code instructions to perform: storing in a computer, a plurality of touchpoint encounters that represent marketing messages exposed to a. plurality of users, as stimulus data records, and a plurality of responses by the users to the marketing messages as response data records, wherein each of the touchpoint encounters comprise a plurality of attributes (see module 9B20); training, using machine-learning techniques in a computer, the response data records and the stimulus data records to generate a touchpoint response predictive model that reflects importance of the attributes, relative to other attributes, to the response of the marketing message (see module 9B30); storing, in a computer, the touchpoint response predictive model (see module 9B40); receiving a plurality of touchpoint encounters for a plurality of users for a brand engagement marketing campaign (see module 9B50); receiving, through an interface of the computer, a plural of brand engagement weighting parameters that identify importance of one or more of the touchpoint encounters to brand engagement (see module 9B60); calculating, in the computer, using the touchpoint response predictive model, a plurality of touchpoint contribution values (see module 9B70); and converting, in the computer, using the brand, engagement event weighting parameters, the touchpoint contribution values to a plurality of weighted touchpoint contribution values for the touchpoint encounters, wherein the weighted touchpoint contribution values measure contribution of the touchpoint encounters to achieve brand engagement (see module 9B80).

### Additional System Architecture Examples

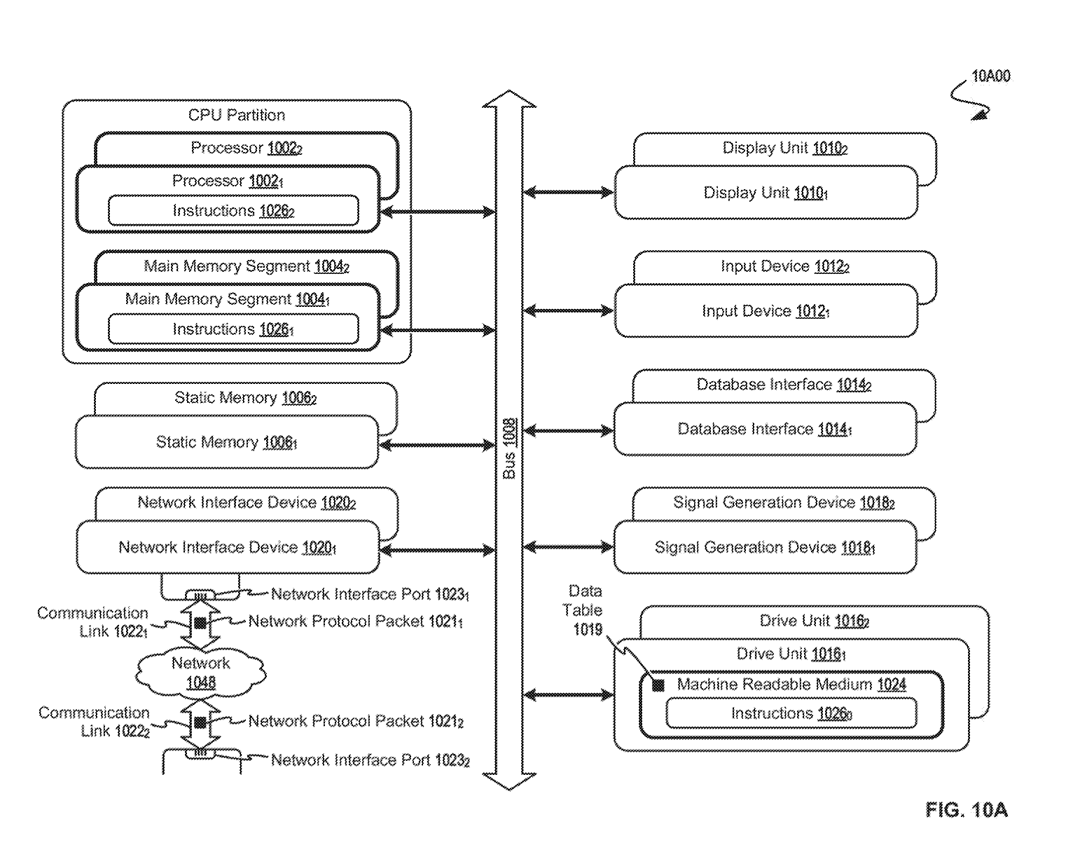

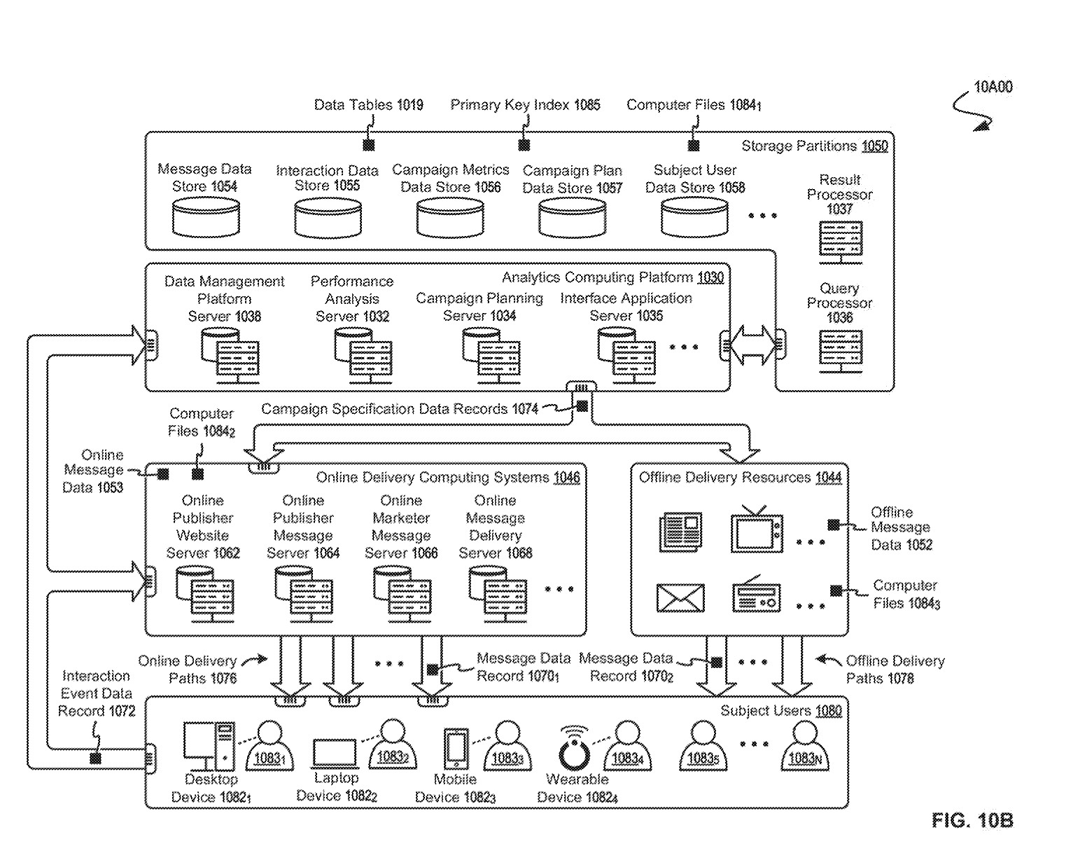

FIG. 10A depicts a diagrammatic representation of a machine in the exemplary form of a computer system 10A00 within which a set of instructions for ca using the machine to perform any one of the methodologies discussed above may be executed. In alternative embodiment the machine may compile a network router, a network switch, a network bridge, a personal digital assistant (PDA), a cellular telephone, a web appliance or any machine capable of executing a sequence of instructions that specify actions to be taken by that machine.

The computer system 10A00 includes a CPU partition having one or more processors (e.g., processor 1002₁, processor 1002₂, etc.), a main memory comprising one or more main memory segments (e.g., main memory segment 1004₁, main memory segment 1004₂, etc.), and one or more static memories (e.g., static memory 1006₁, static memory 1006₂, etc.), any of which components communicate with each other via a bus 1008. The computer system 10A00 may further include one or more video display units (e.g., display unit 1010₁, display unit 1010₂, etc.) The computer system 10A00 can also include one more input devices (e.g., input device 1012₁, input device 1012₂, alphanumeric input device, keyboard, pointing device, mouse, etc.), one or more database interfaces (e.g., database interface 1014₁, database interface 1014₂, etc.), one or more disk drive units (e.g., drive unit 1016₁, drive unit 1016₂, etc.), one or more signal generation devices (e.g., signal generation device 1018₁, signal generation device 1018₂, etc.), and one or more network interface devices (e.g., network interface device 1020₁, network interface device 1020₂, etc.).

The disk drive units can include one or more instances of a machine-readable medium 1024 on which is stored one or more instances of a data table 1019 to store electronic information records. The machine-readable medium 1024 can further store a set of instructions 1026₀ (e.g., software) embodying anyone, or all, of the methodologies described above.

A set of instructions 1026₁ can also be stored within the main memory (e.g., in main memory segment 1004₁). Further, a set of instructions 1026₂ can also be stored within the one or more processors (e.g., processor 1002₁). Such instructions and/or electronic information may further be transmitted or received via the network interface devices at one or more network interface ports (e.g., network interface port 1023₁, network interface port 1023₂, etc.). Specifically, the network interface devices can communicate electronic information across a network using one or more optical links, Ethernet links, wireline links, wireless links, and/or other electronic communication links (e.g., communication link 1022₁, communication link 1022₂, etc.). One or more network protocol packets (e.g., network protocol packet 1021₁, network protocol packet 1021₂, etc.) can be used to hold the electronic information (e.g., electronic data records) for transmission across an electronic communications network (e.g., network 1048). In some embodiments, the network 1048 may include, without limitation, the web (i.e., the Internet), one or more local area networks (LANs), one or more wide area networks (WANs), one or more wireless networks, and/or one or more cellular networks.

The computer system 10A00 can be used to implement a client system and/or a server system, and/or any portion of network infrastructure.

It is to be understood that various embodiments may be used as, or to support, software programs executed upon some form of processing core (such, as the CPU of a computer) or otherwise implemented or realized upon or within, a machine or computer readable medium. A machine-readable medium includes any mechanism for storing or transmitting information in a form readable by a machine (e.g., a computer). For example, a machine-readable medium includes read-only memory (ROM), random access memory (RAM), magnetic disk storage media, optical storage media, flash memory devices, or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 1002₁, processor 1002₂, etc.).

FIG. 10B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 1048) using one or more electronic communication links (e.g., communication link 1022₁, communication link 1022₂, etc.). Such communication links may further use supporting hardware such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 1023₁, network interface port 1023₂, etc.). In one or more embodiments, one or more network protocol packets (e.g., network protocol packet 1021₁, network protocol packet 1021₂, etc.) can be used to bold the electronic information comprising the signals.

As shown, the data processing system can be used by one or more advertisers to target a set of subject users 1080 (e.g., user 1083₁, user 1083₂, user 1083₃, user 1083₄, user 1083₅, . . . , user 1083_{N}) in various marketing campaigns. The data processing system can further be used to determine, by an analytics computing platform 1030, various characteristics (e.g., performance metrics, etc.) of such marketing campaigns.

In some embodiments, the interaction event data record 1072 comprises bottom up data suitable for computing, in performance analysis server 1032, bottom up attribution. In other embodiments, the interaction event data record 1072 and offline message data 1052 comprise top down data suitable for computing, in performance analysis server 1032, top down attribution. In yet other embodiments, the interaction event data record 1072 and offline message data 1052 comprises data suitable for computing, in performance analysis server 1032, both bottom up and top down attribution.

The interaction event data record 1072 comprises, in part, a plurality of touchpoint encounters that represent the subject users 1080 exposure to marketing message(s). Each of these touchpoint encounters comprises a number of attributes, and each attribute comprises an attribute value. For example, the time of day during which the advertisement appeared, the frequency with which it was repeated, and the type of offer being advertised are all examples of attributes for a touchpoint encounter. Each attribute of a touchpoint may have a range of values. The attribute value range may be fixed or variable. For example, the range of attribute values for a day of the week attribute would be seven, whereas the range of values for a weather attribute may depend on the level of specificity desired. The attribute values may be objective (e.g., timestamp) or subjective (e.g., the relevance of the advertisement to the day's news cycle). For a “Publisher” attribute example (i.e., publisher of the marketing message), some examples of attribute values may be “Yahoo! Inc.”, “WSI.com”, “Seeking Alpha”, “NY Times Online”, “CBS Matchwatch”, “MSN Money”, “CBS Interactive”, “YuMe”, and “IH Remnant.”

The interaction event data record 1072 may pertain to various touchpoint encounters tor an advertising or marketing campaign and the subject users 1080 who encountered each touchpoint. The interaction event data record 1072 may include entries that list each instance of a consumer's encounter with a touchpoint and whether or not that consumer converted. The interaction event data record 1072 may be gathered a variety of sources such as Internet advertising impressions and responses (e.g., instances of an advertisement being served to a user and the user's response, such as clicking on the advertisement). Offline message data 1052, such as conversion data pertaining to television, radio, or print advertising, may be obtained from research and analytics agencies or other external entities that specialize in the collection of such data.

According to one embodiment, to compute bottom up attribution in performance analysis server 1032, the raw touchpoint and conversion data (e.g., interaction event data record 1072 and offline message data 1052) is prepared tor analysis. For example, the data may be grouped according to touchpoint, user, campaign, or any other scheme that facilitates ease of analysis. All of the subject users 1080 that encountered the various touchpoints of a marketing campaign are identified. The subject users 1080 are divided between those who converted (i.e., performed a desired action as a result of the marketing campaign) and those who did not convert, and the attributes and attribute values of each touchpoint encountered by the subject users 1080 are identified. Similarly, all of the subject users 1080 that converted are identified. For each touchpoint encounter, this set of users is divided between those who encountered the touchpoint and those who did not. Using this data, the importance of each attribute of the various advertising touchpoints is determined, and the attributes of each touchpoint are ranked according to importance. Similarly, for each attribute and attribute value of each touchpoint, the likelihood that a potential value of that attribute might influence a conversion is determined.

According to some embodiments, attribute importance and attribute value importance maybe modeled, using machine-learning techniques, to generate weights that are assigned to each attribute and attribute value, respectively. In some embodiments, the weights are determined by comparing data pertaining to converting users and non-converting users. In other embodiments, the attribute importance and attribute value importance may be determined by comparing conversions to the frequency of exposures to touchpoints with that attribute relative to others. In some embodiments, logistic regression techniques are used to determine the influence of each attribute and to determine the importance of each potential value of each attribute. Any machine-learning algorithm may be used without deviating from the spirit or scope of the invention.

An attribution, algorithm is used and coefficients are assigned for the algorithm, respectively, using the attribute importance and attribute value importance weights. The attribution algorithm determines the relative effect of each touchpoint in influencing each Conversion given the attribute weights and the attribute value weights. The attribution algorithm is executed using the coefficients or weights. According to one embodiment, for each conversion, the attribution algorithm outputs a score for every touchpoint that a user encountered prior to converting, where the score represents the touchpoint's relative influence on the user's decision to convert. The attribution algorithm, which calculates the contribution of the touchpoint to the conversion, may be expressed as a function of the attribute importance (e.g., attribute weights) and attribute value lift (e.g., attribute value weights):

Credit Fraction=Σₐ₌₁ⁿf (attribute importanceₐ, attribute value liftₐ)

where:

a represents the attribute, and

n represents the number of attributes.

Further details regarding a general approach to bottom up touchpoint attribution are described in U.S. application Ser. No. 13/492,493 (Attorney Docket No. VISQ.P0001) entitle, “A METHOD SYSTEM FOR DETERMINING TOUCHPOINT ATTRIBUTION”, filed Jun. 8, 2012 now U.S. Pat. No. 9,183,562, the contents of which are incorporated by reference in its entirety in this Application.

Performance analysis server 1032 may also perform top down attribution. In general, a top down predictive model is used to determine the effectiveness of marketing stimulations in a plurality of marketing channels included in a marketing campaign. Data (interaction event data record 1072 and offline message data 1052), comprising a plurality of marketing stimulations and respective measured responses, is used to determine a set of cross-channel weights to apply to the respective measured responses, where the cross-channel weights are indicative of the influence that a particular stimulation applied to a first channel has on the measure responses of other channels. The cross-channel weights are used in calculating the effectiveness of a particular marketing stimulation over an entire marketing campaign. The marketing campaign may comprise stimulations quantified as a number of direct mail pieces, a number or frequency of TV spots, a number of web impressions, a number of coupons printed, etc.

The top down predictive model takes into account cross-channel influence from more spending. For example, the effect of spending more on TV ads might influence viewers to “log in” (e.g., to access a website) and take a survey or download a coupon. The top down predictive model also takes into account counterintuitive cross-channel effects from a single channel model. For example, additional spending on a particular channel often suffers from measured diminishing returns (e.g., the audience “tunes out” after hearing a message too many times). Placement of a message can reach a “saturation point” beyond which point further desired behavior is not apparent in the measurements in the same channel. However additional spending beyond the single-channel saturation point may correlate to improvements in oilier channels.

One approach to advertising portfolio optimization uses marketing attributions and predictions determined from historical data (interaction event data record 1072 and offline message data 1052). Analysis of the historical data serves to infer relationships between marketing stimulations and responses. In some cases, the historical data comes from “online” outlets, and is composed of individual user-level data, where a direct cause-effect relationship between stimulations and responses can be verified. However, “offline” marketing channels, such as television advertising, are of a nature such that indirect measurements are used when developing models used in media spend optimization. For example, some stimuli are described as an aggregate (e.g., “TV spots on Prime Time News, Monday, Wednesday and Friday”) that merely provides a description of an event or events as a time-series of marketing stimulations (e.g., weekly television advertising spends). Responses to such stimuli are also often measured and/or presented in aggregate (e.g., weekly unit sales reports provided by the telephone sales center). Yet, correlations, and in some cases causality and inferences, between stimulations and responses can be determined via statistical methods.

The top down predictive model considers cross-channel effects even when direct measurements are not available. The top down predictive model may be formed using any machine learning techniques. Specifically, a top down predictive model may be formed using techniques where variations (e.g., mixes) of stimuli are used with the learning model to capture predictions of what would happen if a particular portfolio variation were to be carried-out. The learning model produces a set of predictions, one set of predictions for each variation. In this manner, variation s of stimuli produce predicted responses, which are used in weighting and filtering, which in turn result in a simulated model being output that includes cross-channel predictive capabilities.

In one example, a portfolio schematic includes three types of media, namely TV, radio and print media. Each media type may have one or more spends. For example. TV may include stations named CH1 and CH2. Radio includes a station named KVIQ. Print media may comprise distribution In the form of mail, a magazine and/or a printed coupon. For each media, there is one or more stimulations (e.g., S1, S2, . . . , SN) and its respective response (e.g., R1, R2, R3 . . . , RN). There is a one-to-one correspondence between a particular stimulus and its response. The stimuli and responses discussed herein are often formed as a time-series of individual stimulations and responses, respectively. For notational convenience, a time-series is given as a vector, such as vector S1.

Continuing the discussion of the example portfolio, the portfolio includes spends for TV such as the evening news, weekly series, and/or morning shows. The portfolio also includes radio spends in the form of a sponsored public service announcement, a sponsored shock jock spot, and/or a contest. The example portfolio may further include spends for radio station KVIQ, a direct mailer, and magazine print ads (e.g., coupon placement). The portfolio also includes spends for print media in the form of coupons.

The example portfolio may be depicted as stimulus vectors (e.g., S1, S2, S3, S4, S5, S6, S7, S8, and SN). The example portfolio may also show a set of response measurements to be taken, such as response vectors (e.g., R1, R2, R3, R4, R5, R6, R7, R8, and RN).

A vector S̅1̅ may comprise a time-series. The time-series may be presented in a native time unit (e.g., weekly, daily) and may be apportioned over a different time unit. For example, stimulus vector SI corresponds to a weekly spend for “Prime Time News” even though the stimulus to be considered actually occurs nightly (e.g., during “Prime Time News”). The weekly spend stimulus can be apportioned to a nightly stimulus occurrence. In some situations, the time unit in a time-series can be very granular (e.g., by the minute). Apportioning can be performed using any known techniques. Stimulus vectors and response vectors can be formed from any time-series in any time units and can be apportioned to another time-series using any other time units.

A particular stimulus in a first marketing channel (e.g., S̅1̅) might produce corresponding results (e.g., R̅1̅). Additionally, a stimulus in a first marketing channel (e.g., S̅1̅) might produce results (or lack of results) as given by measured results in a different marketing channel (e.g., R̅3̅). Such correlation of results, or lack of results, can be automatically detected, and a scalar value representing the extent of correlation can be determined mathematically from any pair of vectors. In the discussions just below, the correlation of a time-series response vector is considered with respect to a time-series stimulus vector. Correlations can be positive (e.g., the time-series data moves in the same direction), or negative (e.g., the time-series data moves in the opposite direction), or zero (no correlation).

An example vector S̅1̅ is composed of a series of changing values. The response R̅1̅ may be depicted as a curve. Maximum value correlation occurs when die curve is relatively time-shifted, by Δt amount of time, to another. The amount of correlation and amount of time shift can be automatically determined. Example cross-channel correlations are presented in Table 1.

TABLE 1
Cross-correlation examples

| Stimulus Channel → | |
|---|---|
| Cross-channel | Description |
| S1 → R2 | No correlation |
| S1 → R3 | Correlates if time shifted and attenuated |
| S1 → R4 | Correlates if time shifted and amplified |

In some cases, a correlation calculation can identify a negative correlation

where an increase in a first channel causes a decrease in a second channel. Further, in some cases, a correlation calculation can Identify an Inverse correlation where a large increase in a first channel causes a small increase in a second channel. In still further cases, there can be no observed correlation, or in some cases a correlation is increased when exogenous variables are considered.

In some cases a correlation calculation can hypothesize one or more causation effects, and in some cases correlation conditions are considered when calculating a correlation such that a priori known conditions can be included (or excluded) from the correlation calculations.

The automatic detection can proceed autonomously. In some cases correlation parameters are provided to handle specific correlation cases. In one case, the correlation between two time-series can be determined to a scalar value using the following equation:

$$r = \frac{n \sum xy - ( \sum x ) ( \sum y )}{\sqrt{n ( \sum {x}^{2} ) - {( \sum x )}^{2}} \sqrt{n ( \sum {y}^{2} ) - {( \sum y )}^{2}}}$$

where:

x represents components of a first time-series,

y represents components of a second time-series, and

n is the number of {x, y} pairs.

In some cases, while modeling a time-series, not all the scaler values in the time-series are weighted equally. For example, more recent time-series data values found in the historical data are given a higher weight as compared to older ones. Various shapes of weights to overlay a time-series are possible, and one exemplary shape is the shape of an exponentially decaying model.

Use of exogenous variables might involve considering seasonality factors or other factors that are hypothesized to impact, or known to impact, the measured responses. For example, suppose the notion of seasonality is defined using quarterly time graduations, and the measured data shows only one quarter (e.g., the 4ₜₕ quarter) from among a sequence of four quarters in which a significant deviation of a certain response is present in the measured data. In such a case, any of the aforementioned exogenous variables can be used to define a variable that lumps a set of distinct variables into a lumped variable (e.g., by lumping four occurrences of quarterly periodic data into a lumped yearly variable).

Further details of a top. down predictive model are described in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013, the contents of which are incorporated by reference in its entirety in this Application.

Other operations, transactions and/or activities associated with the data processing system are possible. Specifically, the subject users 1080 can receive a plurality of online message data 1053 transmitted through any of a plurality of online delivery paths 1076 (e.g., online display, search, mobile ads, etc.) to various computing devices (e.g., desktop device 1082₁, laptop device 1082₂, mobile device 1082₃, and wearable device 1082₄). The subject users 1080 can further receive a plurality of offline message data 1052 presented through any of a plurality of offline delivery paths 1078 (e.g., TV, radio, print, direct mail, etc.). The online message data 1053 and/or the offline message data 1052 can be selected for delivery to the subject users 1080 based in part on certain instances of campaign specification data records 1074 (e.g., established by the advertisers and/or the analytics computing platform 1030).

For example, the campaign specification data records 1074 might comprise settings, rules, taxonomies, and other information transmitted electronically to one or more instances of online deli very computing systems 1046 and/or one or more instances of offline delivery resources 1044. The online delivery computing systems 1046 and/or the offline delivery resources 1044 can receive and store such electronic information in the form of instances of computer files 1084₂ and computer files 1084₃, respectively. In one or more embodiments, the online delivery computing systems 1046 can comprise computing resources such as an online publisher website server 1062, an online publisher message server 1064, an online marketer message server 1066, an online message delivery server 1068, and other computing resources. For example, the message data record 1070₂ presented to the subject users 1080 through the online delivery paths 1076 can be transmitted through the communications links of the data processing system as instances of electronic data records using various protocols (e.g., HTTP, HTTPS, etc.) and structures (e.g., JSON), and then rendered on the computing devices in various forms (e.g., digital picture, hyperlink, advertising tag, test message, email message, etc.). The message data record 1070₂ presented to the subject users 1080 through the-offline delivery paths 1078 can be transmitted as sensory signals in various forms (e.g., printed pictures and text, video, audio, etc.).

The analytics computing platform 1030 can receive instances of an interaction event data record 1072 comprising certain characteristics and attributes of the response of the subject users 1080 to the message data record 1070₁ the message data record 1070₂, and/or other received messages. For example, the interaction event data record 1072 can describe certain online actions taken by the users on the computing devices such as visiting a certain URL, clicking a certain link, loading a web page that fires a certain advertising tag, completing an online purchase, and other actions. The interaction event data record 1072 may also include information pertaining to certain offline actions taken by the users such as purchasing a product in a retail store, using a printed coupon, dialing a toll-free number, and other actions. The interaction event data record 1072 can be transmitted to the analytics computing platform 1030 across the communications links as instances of electronic data records using various protocols and structures. The interaction event data record 1072 can further comprise data (e.g., user identifier, computing device identifiers, timestamps, IP addresses, etc.) related to the users and/or the users' actions.

The interaction event data record 1072 and other data generated and used by die analytics computing platform 1030 can be stored in one or more storage partitions 1050 (e.g., message data store 1054, interaction data store 1055, campaign metrics data store 1056, campaign plan data store 1057, subject user data store 1058, etc.). The storage partitions 1050 can comprise one or more databases and/or other types of non-volatile storage facilities to store data in various formats and structures (e.g., data tables 1019, computer files 1084₁, etc.). The data stored in the storage partitions 1050 can be made accessible to the analytics computing platform 1030 by a query processor 1036 and a result processor 1037, which can use various means for accessing and presenting the data, such as a primary key index 1085 and/or other means.

In one or more embodiments, the analytics computing platform 1030 can comprise a performance analysis server 1032 and a campaign planning server 1034. Operations performed by the performance analysis server 1032 and the campaign planning server 1034 can vary widely by embodiment. As an example, the performance analysis server 1032 can be used to analyze the messages presented to the users (e.g., message data record 1070₁ and message data record 1070₂) and the associated instances of the interaction event data record 1072 to determine various performance metrics associated with a marketing campaign, which metrics can be stored in the campaign metrics data store 1056 and/or used to generate various instances of the campaign specification data records 1074.

Further, for example, the campaign planning server 1034 can be used to generate marketing campaign plans and associated marketing spend apportionments, which information can be stored in the campaign plan data store 1057 and/or used to generate various instances of the campaign specification data records 1074. Certain portions of the interaction event data record 1072 might further be used by a data management platform server 1038 in the analytics computing platform 1030 to determine various user attributes (e.g., behaviors, intent, demographics, device usage, etc.), which attributes can he stored in the subject user data store 1058 and/or used to generate various instances of the campaign specification data records 1074. One or more instances of an interface application server 1035 can execute various software applications that can manage and/or interact with the operations, transactions, data, and/or activities associated with the analytics computing platform 1030. For example, a marketing manager might interface with the interface application server 1035 to view the performance of a marketing campaign, and/or to allocate media spend for another marketing campaign.

In the foregoing specification, the disclosure has been described with reference to specific embodiments thereof. It will, however, be evident that various modifications and change may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, are to be regarded in an illustrative sense rather than in a restrictive sense.

What is claimed is:

1. A computer implemented method for determining touchpoint attribution in brand engagement, comprising:
storing in a computer, a plurality of touchpoint encounters that represent marketing messages exposed to a plurality of users, as stimulus data records, and a plurality of responses by the users to the marketing messages as response data records, wherein each of the touchpoint encounters comprise a plurality of attributes;
training, using machine-learning techniques in a computer, the response data records and the stimulus data records to generate a touchpoint response predictive model that reflects importance of the attributes, relative to other attributes, to the response of the marketing message;
storing, in a computer, the touchpoint response predictive model;
receiving a plurality of touchpoint encounters for a plurality of users for a brand engagement marketing campaign;
receiving, through an interface of the computer, a plurality of brand engagement event weighting parameters that identify importance of one or more of the touchpoint encounters to brand engagement;
calculating, in the computer, using the touchpoint response predictive model, a plurality of touchpoint contribution values; and
converting, in the computer, using the brand engagement event weighting parameters, the touchpoint contribution values to a plurality of weighted touchpoint contribution values for the touchpoint encounters, wherein the weighted touchpoint contribution values measure contribution of the touchpoint encounters to achieve brand engagement.

2. The method of claim 1, wherein the brand engagement is measured by engagement scores generated by a sum using an additive arithmetic operator and a product using a multiplicative arithmetic operator.

3. The method of claim 1, wherein the brand engagement event weighting parameters are selected from a user configuration.

4. The method of claim 1, further comprising generating a set of predicted media spend allocation performance parameters.

5. The method of claim 4, wherein the predicted media spend allocation performance parameters are genera ted based at least in part on a predicted performance value.

6. The method of claim 5, wherein the predicted performance value is derived from at least one of, an engagement level calculation or a return on investment (ROI) calculation.

7. The method of claim 5, further comprising determining a media spend plan based at least in part on at least a portion the predicted media spend allocation performance parameters.

8. The method of claim 1, wherein the brand engagement event weighting parameters correspond to at least one of, a first-time website visit event or a whitepaper download event, or a video completion event, or a product review form completion event, or a sweepstakes submission event, or rich media ad interaction event, or any combination thereof.

9. A computer readable medium, embodied in a non-transitory computer readable medium, the non-transitory computer readable medium having stored thereon a sequence of instructions which, when stored in memory and executed by a processor causes the processor to perform a set of acts for determining touchpoint attribution in brand engagement, the acts comprising:
storing in a computer, a plurality of touchpoint encounters that represent marketing messages exposed to a plurality of users, as stimulus data records, and a plurality of responses by the users to the marketing messages as response data records, wherein each of the touchpoint encounters comprise a plurality of attributes;
training, using machine-learning techniques in a computer, the response data records and the stimulus data records to generate a touchpoint response predictive model that reflects importance of the attributes, relative to other attributes, to the response of the marketing message;
storing, in a computer, the touchpoint response predictive model;
receiving a plurality of touchpoint encounters for a plurality of users for a brand engagement marketing campaign;
receiving, through an interface of the computer, a plurality of brand engagement event weighting parameters that identify importance of one or more of the touchpoint encounters to brand engagement;
calculating, in the computer, using the touchpoint response predictive model, a plurality of touchpoint contribution, values; and
converting, in the computer, using the brand engagement event weighting parameters, the touchpoint contribution values to a plurality of weighted touchpoint contribution values for the touchpoint encounters, wherein the weighted touchpoint contribution values measure contribution of the touchpoint. encounters to achieve brand engagement.

10. The computer readable medium of claim 9, wherein the brand engagement is measured by engagement scores generated by a sum using an additive arithmetic operator and a product using a multiplicative arithmetic operator.

11. The computer readable medium of claim 9, wherein the brand engagement event weighting parameters are selected from a user configuration

12. The computer readable medium of claim 9, further comprising instructions which, when stored in memory and executed by the processor causes the processor to perform acts of generating a set of predicted media spend allocation performance parameters.

13. The computer readable medium of claim 12, wherein the predicted media spend allocation performance parameters are generated based at least in part on a predicted performance value.

14. The computer readable medium of claim 13, wherein the predicted performance value is derived from at least one of an engagement level calculation or a return on investment (ROI) calculation.

15. The computer readable medium of claim 13, further comprising instructions which, when stored in memory and executed by the processor causes the processor to perform acts of determining a media spend plan based at least in part on at least a portion the predicted media spend allocation performance parameters.

16. The computer readable medium of claim 9, wherein the brand engagement event weighting parameters correspond to at least one of a first-time website visit event, or a whitepaper download event, or a video completion event, or a product review form completion event, or a sweepstakes submission event, or rich media ad interaction event, or any combination thereof.

17. A system for determining touchpoint attribution in brand engagement comprising:
a storage medium having stored thereon a sequence of instructions; and
a processor or processors that execute the instructions to cause the processor or
processors to perform a set of acts, the acts comprising,
storing in a computer, a plurality of touchpoint encounters that represent marketing messages exposed to a plurality of users, as stimulus data records, and a plurality of responses by the users to the marketing messages as response data records, wherein each of the touchpoint encounters comprise a plurality of attributes;
training, using machine-learning techniques in a computer, the response data records and the stimulus data records to generate a touchpoint response predictive model that reflects importance of the attributes, relative to other attributes, to the response of the marketing message;
storing, in a computer, the touchpoint response predictive model;
receiving a plurality of touchpoint encounters for a plurality of users for a brand engagement marketing campaign;
receiving, through an interface of the computer, a plurality of brand engagement event weighting parameters that identify importance of one or more of the touchpoint encounters to brand engagement;
calculating, in the computer, using the touchpoint response predictive model, a plurality of touchpoint contribution values; and
converting, in the computer, using the brand engagement event weighting parameters, the touchpoint contribution values to a plurality of weighted touchpoint contribution values for the touchpoint encounters, wherein the weighted touchpoint contribution values measure contribution of the touchpoint encounters to achieve brand engagement.

18. The system of claim 17, wherein the brand engagement is measured by engagement scores generated by a sum using an additive arithmetic operator and a product using a multiplicative arithmetic operator.

19. The system of claim 17, wherein the brand engagement e vent weighting parameters are selected from a user configuration.

20. The system of claim 17, further comprising generating predicted media spend allocation performance parameters based at least in part on a predicted performance value.
